(19) United States
(12) Patent Application Publication
(10) Pub. No.: US 2011/0320754 A1
(43) Pub. Date: Dec. 29, 2011

(54) MANAGEMENT SYSTEM FOR STORAGE SYSTEM AND METHOD FOR MANAGING STORAGE SYSTEM

(75) Inventors: Naoko Ichikawa, Sagamihara (JP); Yoshiaki Eguchi, Yokohama (JP); Yuichi Taguchi, Sagamihara (JP)

(73) Assignee: HITACHI, LTD, Chiyoda-ku, Tokyo (JP)

(21) Appl. No.: 12/679,452

(22) PCT Filed: Feb. 23, 2010
(86) PCT No.: PCT/JP2010/001189

§ 371 Date: Sep. 1, 2011

(51) Int. Cl. G06F 12/00

(52) U.S. Cl. 711/165; 711/E12.002

(57) ABSTRACT

Provided is a management system for a storage system, the storage system including a first storage subsystem and a second storage subsystem each including logical storage areas for storing data to be processed by a host computer, the logical storage areas in each of the first and second storage subsystems having storage tiers associated respectively with a plurality of storage area characteristic information pieces which are information pieces characterizing the corresponding logical storage areas and which are different from each other, the management system comprising a data migration management part, wherein when the data is migrated from the first storage subsystem to the second storage subsystem, the data migration management part: acquires a configuration of the storage tiers of the logical storage areas of the first storage subsystem in which the data of a migration target is stored; compares the configuration with a configuration of the storage tiers of the logical storage areas of the second storage subsystem; and then migrates the migration target data stored in the logical storage areas of the first storage subsystem to the logical storage areas of the second storage subsystem in accordance with a result of the comparison.

### TECHNICAL FIELD

The present invention relates to a management system for a storage system and a method for managing a storage system. In particular, the present invention relates to a management system for a storage system and a method for managing a storage system, which, in data migration processing between storage subsystems, implement data migration to a migration destination storage subsystem while maintaining a storage tier configuration in a migration source storage subsystem.

### BACKGROUND ART

In general, a storage system includes a host computer which issues a write or read request for data and a storage subsystem which receives the write or read request and stores data regarding the request. The storage subsystem includes one or multiple physical storage devices, and provides the host computer with logical storage areas (hereinafter, referred to as “logical volumes”) which are configured of the one or multiple physical storage devices. The storage areas are different from one another in characteristics, including performance, reliability, and cost, depending on factors such as the configurations of the logical volumes, i.e., the types of the physical devices, the RAID types, and the like. Generally, a storage area having higher performance and higher reliability is higher in cost while a storage area having lower performance and lower reliability is lower in cost.

In a storage system, a storage tiering technique has been employed. Specifically, in the storage tiering technique, such storage areas having different characteristics are classified and defined as “tiers”, and each of the tiers is used differently depending on the value, characteristics, lifecycle, and the like of data to be stored. In general, a storage area having higher performance and higher reliability is used as a higher tier, while a storage area having lower performance and lower reliability is used as a lower tier. In such a tiered storage system, for example, data having a high access frequency is stored in a higher tier while data having a low access frequency is stored in a lower tier.

In addition, in such a storage system having tiered storage areas, a storage area of a higher tier is generally high in cost, and is thus desired to be used more effectively. To put it differently, there is a characteristic in which a storage area in a higher tier is more utilized.

PTL 1 discloses the following technique. Specifically, each of segments of logical storage areas is evaluated in terms of the value and characteristics (access frequency and the like) of data. In accordance with the result of the evaluation, data stored in a real data storage area (a storage area that actually stores data) associated with each segment is migrated between multiple real data storage areas having different characteristics from one another. PTL 1 states that using this technique makes it possible to manage storage tiers in units of segments forming logical volumes, in accordance with characteristics of data stored in the segments.

In addition, in the operation of a storage system, there is a case where data has to be migrated between multiple storage subsystems in response to a requirement on business, such as replacement of a storage subsystem. PTL 2 discloses a technique that makes it possible to migrate data from a storage subsystem of a migration source to a storage subsystem of a migration destination without interrupting an access from a host computer to the data in the storage subsystem, and thus allows the migrated data to be used from the host computer continuously after migration as well.

Furthermore, PTL 3 discloses a technique for a storage system in which storage areas for multiple files are tiered on the basis of the unique characteristics of the respective files, the technique being for migrating data between storage subsystems while maintaining a tier configuration of files.

### CITATION LIST

### Patent Literature

PTL 1: Specification of United States Patent Application Publication No. 2009/0070541
PTL 2: Japanese Patent Application Laid-open Publication No. 2008-176627
PTL 3: Japanese Patent Application Laid-open Publication No. 2008-15984

### SUMMARY OF INVENTION

### Technical Problem

When migrating data from a storage subsystem to a different storage subsystem by any of the conventional methods, a storage system having multiple storage tiers executes the migration with no consideration given to the storage tiers in the storage subsystems and thereby brings about a problem of losing data allocation in the tiers constructed in the storage subsystem of the migration source. Accordingly, such data having a high access frequency that should normally be stored in a higher tier is stored in a lower tier, resulting in deterioration in performance as a storage system.

According to PTL 3, it is possible to migrate data between storage subsystems while maintaining the storage tiers of files in accordance with the characteristics of the files and the policy specified by the user. However, if storage tiers are managed in units of logical storage areas and pages forming the logical storage areas without using a file system as described in PTL 1, the storage tiers cannot be maintained.

Moreover, a higher tier tends to be more effectively utilized in a storage subsystem in general, as has already been described. Because of this tendency, the following situation may occur. Specifically, if data for business which is different from migration target business data has already been stored in a storage subsystem of a migration destination, there may have already been no free area in a storage area of a higher tier in the storage subsystem. In such case, the data of the migration target is stored in a storage area of a lower tier in the storage subsystem of the migration destination even if the priority of the data is higher than that of the existing data for business in the storage subsystem of the migration destination.

The present invention has been made to solve the above-described and other problems. An object of the present invention is to provide a management system for a storage system and a method for managing a storage system, which, in data migration processing between storage subsystems, implement data migration to a migration destination storage subsystem while maintaining a storage tier configuration in a migration source storage subsystem.

### Solution to Problem

An aspect of the present invention for achieving the above-described object is a management system for a storage system, the storage system including a first storage subsystem and a second storage subsystem each including logical storage areas for storing data to be processed by a host computer, the logical storage areas in each of the first and second storage subsystems having storage tiers associated respectively with a plurality of storage area characteristic information pieces which are information pieces characterizing the corresponding logical storage areas and which are different from each other, the management system comprising a data migration management part, wherein when the data is migrated from the first storage subsystem to the second storage subsystem, the data migration management part: acquires a configuration of the storage tiers of the logical storage areas of the first storage subsystem in which the data of a migration target is stored, compares the configuration with a configuration of the storage tiers of the logical storage areas of the second storage subsystem; and then migrates the migration target data stored in the logical storage areas of the first storage subsystem to the logical storage areas of the second storage subsystem in accordance with a result of the comparison.

### Advantageous Effects of Invention

The present invention makes it possible to provide a management system for a storage system and a method for managing a storage system, which, in data migration processing between storage subsystems, implement data migration to a migration destination storage subsystem while maintaining a storage tier configuration in a migration source storage subsystem.

### BRIEF DESCRIPTION OF DRAWINGS

FIG. 1 is a diagram showing a coupling configuration of a storage system 1 according to an example of the present invention.

FIG. 2 is a diagram showing an internal configuration of a first storage subsystem 300.

FIG. 3 is a diagram showing relationships among storage devices, logical volumes, pages, and a virtual volume, in the storage system 1.

FIG. 4 is a diagram showing a program group and a management table group held by a program memory 350 in the first storage subsystem 300.

FIG. 5 is a diagram showing an example of a tier control performed by a tier control program 354.

FIG. 6 is a diagram showing an example of a logical volume management table 356.

FIG. 7 is a diagram showing an example of a page management table 357.

FIG. 8 is a diagram showing an example of a virtual volume management table 358.

FIG. 9 is a diagram showing an example of a tier management table 359.

FIG. 10 is a diagram showing an example of page-unit tier management map information 35a.

FIG. 11 is a diagram showing an example of an TO monitor management table 35b.

FIG. 12 is a diagram showing an internal configuration of a management computer 200 employed in Example 1.

FIG. 13A is a diagram showing an example of a storage subsystem tier configuration management table 273A.

FIG. 13B is a diagram showing an example of a storage subsystem tier configuration management table 273B.

FIG. 14 is a diagram showing an example of a storage area management table 274.

FIG. 15 is a flowchart showing an example of a processing flow of data migration performed by a data migration management program 272.

FIG. 16 is a flowchart showing an example of a detailed processing flow of “acquiring page-unit tier configuration information of a target volume” in Step 1002 in FIG. 15.

FIG. 17 is a flowchart showing an example of a detailed processing flow of “acquiring tier configuration information on a migration destination storage subsystem” in Step 1003 in FIG. 15.

FIG. 18 is a flowchart showing an example of a detailed processing flow of “determining a storage tier configuration after migration” in Step 1004 in FIG. 15.

FIG. 19 is a flowchart showing an example of a detailed processing flow of “preparing a storage area in a migration destination” in Step 1005 in FIG. 15.

FIG. 20A is a flowchart showing an example of a detailed processing flow of “data migration” in Step 1006 in FIG. 15.

FIG. 20B is a flowchart showing an example of a detailed processing flow of “data migration” in Step 1006 in FIG. 15, and shows a different method from that of the processing flow shown in FIG. 20A.

FIG. 21 is a flowchart showing an example of a detailed processing flow of “data migration” in Step 1006 in FIG. 15, and shows a different method from those of the processing flows shown in FIG. 20A and FIG. 20B.

FIG. 22 shows an example of a management screen allowing an administrator to define a storage tier.

FIG. 23 shows an example of a warning message and a management screen outputted in Step 1306, described in FIG. 18.

FIG. 24 is a diagram showing an example of an internal configuration of a management computer 200 in Examples 2 and 3.

FIG. 25 is a flowchart showing an example of a processing flow of data migration executed by a data migration management program 272 in Example 2.

FIG. 26 is a flowchart showing an example of a detailed processing flow of “acquiring IO statistics information on a page” in Step 2004 in FIG. 25.

FIG. 27 is a flowchart showing an example of a detailed processing flow of “determining a tier configuration after migration” in Step 2005 in FIG. 25.

FIG. 28A is a diagram showing an example of a storage subsystem tier configuration management table 273A in Example 2.

FIG. 28B is a diagram showing an example of a storage subsystem tier configuration management table 273B in Example 2.

FIG. 29 is a flowchart showing an example of a detailed processing flow of “data migration” in Step 2007 in FIG. 25.

FIG. 30 is a flowchart showing an example of a detailed processing flow of “acquiring TO statistics information of a page” in Step 2004 in FIG. 25, which is employed in Example 3.

FIG. 31 is a flowchart showing an example of a detailed processing flow of “determining a tier configuration after migration” in Step 2005 in FIG. 25, which is employed in Example 3.

FIG. 32 is a diagram showing a migration order of pages determined on the basis of a result of the processing in Step 2004 and Step 2005 in FIG. 25 as well as storage tiers in which the pages are allocated in a migration destination storage subsystem.

FIG. 33 is a flowchart showing an example of a processing flow of data migration in Example 3.

FIG. 34 is a flowchart showing an example of a detailed processing flow of “page migration” in Step 2605 in FIG. 33.

FIG. 35 is a flowchart showing an example of a detailed processing flow of “allocating a page to a designated tier” in Step 2607 in FIG. 33.

FIG. 36 shows an example of a management screen outputting a result of calculating the priority order of each page.

FIG. 37 shows an example of a management screen outputting page-unit IO statistics information collected at the time of data migration and a result of calculating the priority order of each page.

### DESCRIPTION OF EMBODIMENTS

Hereinafter, modes for carrying out the present invention will be described with reference to the accompanying drawings. It should be noted that the function of each of programs which are mentioned in the following description is implemented by a CPU or processor reading out the corresponding program from a memory, and executing the program while referring to information recorded in various management tables.

### Example 1

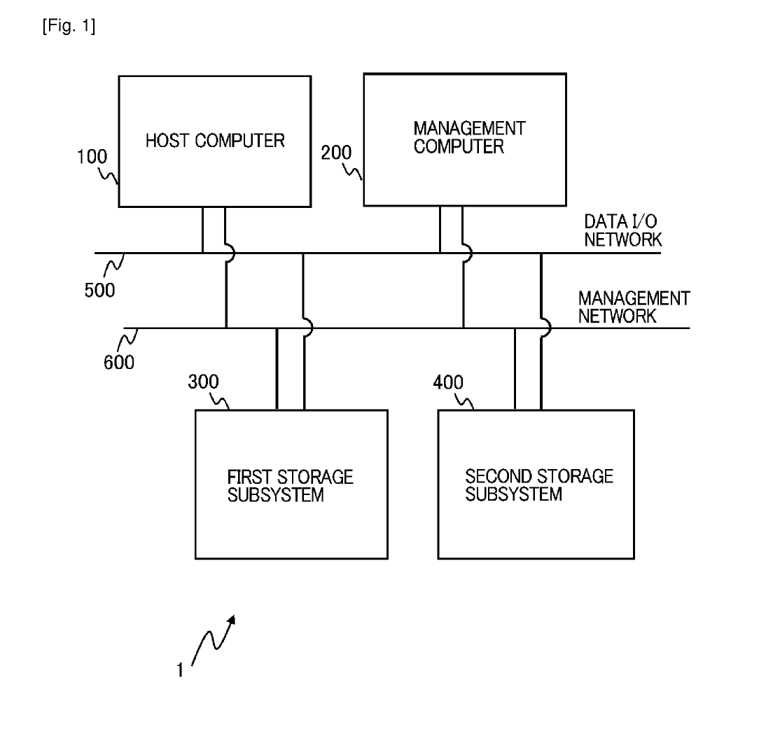

First, Example 1 of the present invention will be described with reference to FIG. 1 to FIG. 23. FIG. 1 is a diagram showing a coupling configuration of a storage system 1 according to Example 1 of the present invention. The storage system 1 of Example 1 includes a host computer 100, a management computer 200, a first storage subsystem 300, and a second storage subsystem 400, which are communicatively coupled to one another through a data I/O network 500 and a management network 600.

The host computer 100 is coupled to the first storage subsystem 300 and the second storage subsystem 400 through the data I/O network 500, and issues write and read requests for data to the first storage subsystem 300 or the second storage subsystem 400. The data I/O network 500 is a general communication network, such as a fibre channel (FC) network or an IP network. The host computer 100 may be a general-purpose computer having a communication function, such as a personal computer (PC) or a server, as will be described later.

The management computer 200 is a computer for performing management on data communications of the first storage subsystem 300, the second storage subsystem 400, and the host computer 100, and is configured as a management system for the storage system 1. The management computer 200 is coupled to the first storage subsystem 300 and the second storage subsystem 400 through the management network 600. The management network 600 is configured as a general communication network, such as an IP network, for example. Note that the management network 600 may be configured to share the same communication network with the aforementioned data I/O network 500.

The management computer 200, the first storage subsystem 300, and the second storage subsystem 400 transmit and receive management information, which will be described later, to one another through the management network 600.

In the storage system 1 shown in FIG. 1, the first storage subsystem 300 is a migration source storage subsystem in data migration processing described in the description, and the second storage subsystem 400 is a migration destination storage subsystem in the data migration processing. Note that the storage system 1 may include three or more storage subsystems. In such a case, the following description will refer to processing between paired migration source and migration destination storage subsystems extracted from the three or more storage subsystems.

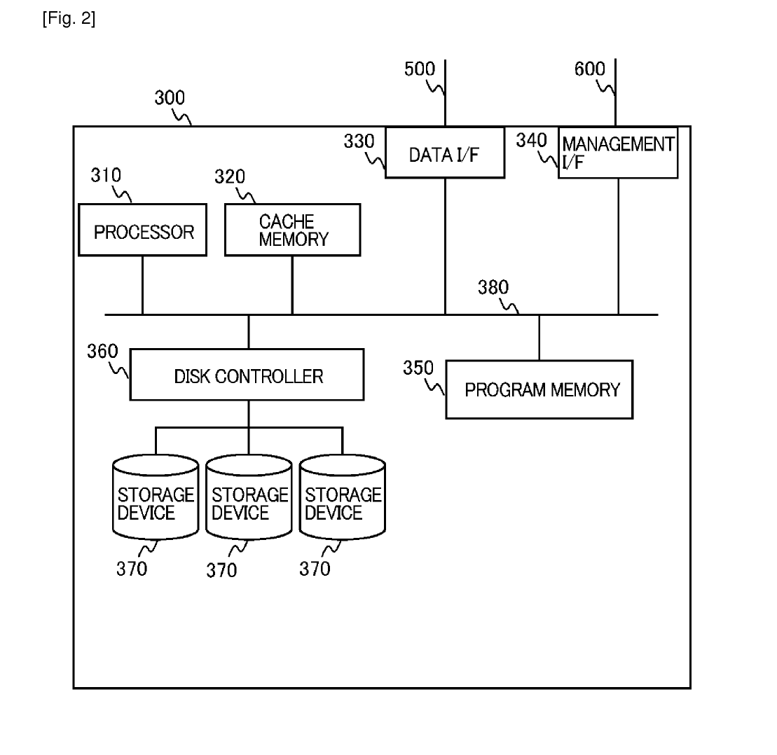

FIG. 2 is a diagram showing an internal configuration of the first storage subsystem 300.

The first storage subsystem 300 includes a processor 310, a cache memory 320, a data I/O interface (I/F) 330, a management I/F 340, a program memory 350, and a disk controller 360, which are all coupled to one another through an internal communication network 380.

In addition, the first storage subsystem 300 includes storage devices 370 each of which stores data to be read or written by the host computer 100. The reading and writing of data from and to each of the storage devices 370 is controlled by the disk controller 360. Communications with the outside of the first storage subsystem 300 are carried out through the data I/O I/F 330 and the management I/F 340, which are prepared separately for different purposes.

The cache memory 320 may be a general semiconductor memory, such as a RAM (Random Access Memory), and is used as a temporary data storage area as in the case of that in a general-purpose computer.

The program memory 350 is a storage area configured by a magnetic disk drive, such as a hard disk drive (hereinafter, referred to as “HDD”), or a semiconductor memory, such as a ROM (Read Only Memory). The program memory 350 holds a group of various programs and information serving the operation of a storage subsystem. The processor 310, such as a CPU (Central Processing Unit), executes the various programs by reading the group of various programs and information from the program memory 350.

The storage devices 370 are configured by, for example, one or more magnetic disk drives, namely devices such as HDDs, memory devices using a flash memory, namely devices called SSDs (Solid State Drives), or the like. Each of the storage devices 370 can be used in such a manner that the storage area of the storage device 370 is logically divided into multiple data storage areas (hereinafter, referred to as “logical volumes) by the disk controller 360 or the like. Note that, when multiple storage devices 370 are provided, the storage devices 370 may be configured as storage devices provided with redundancy with an appropriate RAID (Redundant Array of Inexpensive Disks) level (for example, RAID 5) by applying the RAID configuration thereto, for example.

Moreover, each of the logical volumes is managed by being divided into one or multiple storage area management units (hereinafter, referred to as “pages”). In short, each of the logical volumes is formed of one or multiple pages in this case. Note that, the capacities and the number of the logical volumes and pages are not particularly limited within the range of capacities of physical storage areas provided by the storage devices 370 in the present description.

Meanwhile, since the internal configuration of the second storage subsystem 400 shown in FIG. 1 is basically the same as that of the first storage subsystem 300, the description thereof will be omitted.

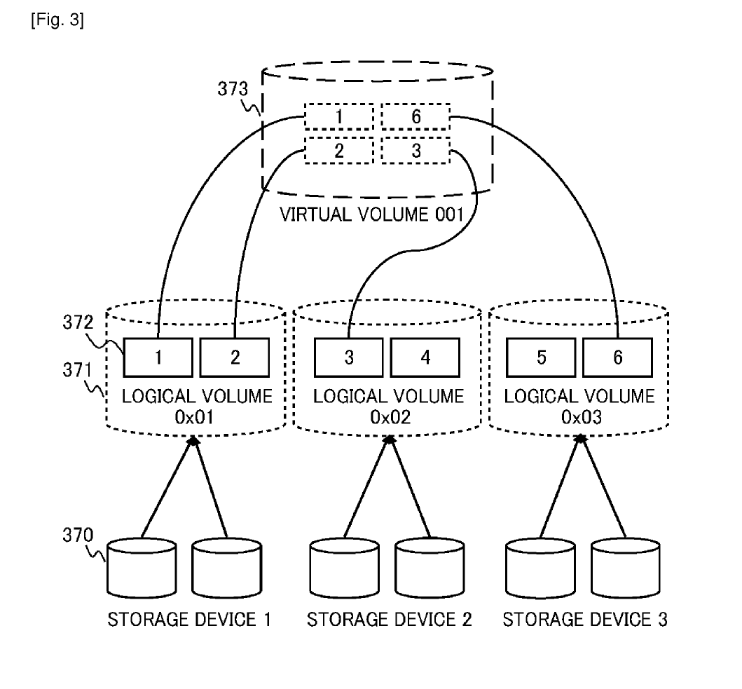

FIG. 3 schematically shows relationships among storage devices, logical volumes, pages, and a virtual volume, in the storage system 1 of Example 1. The one or multiple storage devices 370 form logical volumes 371, which are storage areas logically divided. Each of the logical volumes 371 is given a logical volume ID (for example, “0x01” in FIG. 3) that is an identification code for distinguishing the logical volume 371 from the others. In the example shown in FIG. 3, the six storage devices 370 are divided into three storage device groups, that is, a storage device 1, a storage device 2, and a storage device 3. Each of the storage device groups is characterized by the type of storage media (SSD, HDD, magnetic tapes, or the like), the performance (the rotational speed of the HDD, or the like), and the redundancy (the RAID level or the like).

Moreover, each of the logical volumes 371 includes pages 372 that are management units for the storage area, the management units being formed by dividing the storage area in the logical volume 371 into a finite number of sections. The logical volumes 371 and the pages 372 are utilized as shared storage resources for forming a virtual volume 373, which will be described later.

The virtual volume 373 is virtually created, and is in the form of a logical storage area that is recognized from the host computer 100. In practice, the virtual volume 373 is formed of one or multiple of the pages 372. The pages 372 forming the virtual volume 373 may be configured to be provided by multiple different ones of the logical volumes 371, as shown in FIG. 3. In other words, the virtual volume 373 can be created by employing the Thin Provisioning technique. In the example shown in FIG. 3, three different types of logical volumes 371 (“0x01”, “0x02”, “0x03” in FIG. 3) are created from three different types of storage devices 370. Then, one virtual volume 001 (the code “001” is a virtual volume ID that is an identification code for distinguishing the virtual volume 373 from the others) is formed of the pages 372 extracted from the different types of logical volumes 371.

For example, the virtual volume 001 in FIG. 3 is formed of pages 1 and 2 belonging to the logical volume 0x01 formed of the storage device 1, a page 3 belonging to the logical volume 0x02 formed of the storage device 2, and a page 6 belonging to the logical volume 0x03 formed of the storage device 3.

Note that the types of the logical volumes 371 may not be characterized by the types of the storage devices 370, but may be characterized, as described above, by the configuration of logical volumes, such as the RAID level, for example.

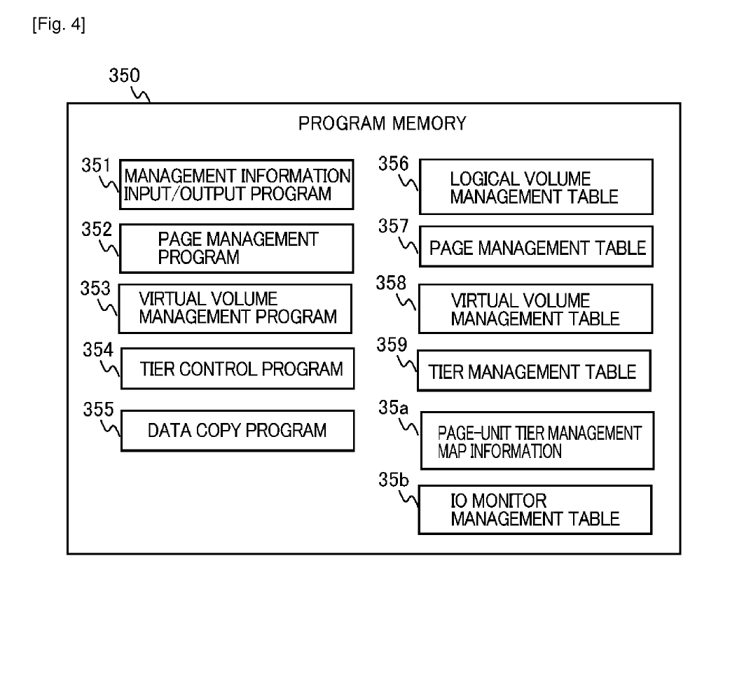

Next, the functions implemented in the first storage subsystem 300 and various management tables storing information used for the functions will be described. FIG. 4 is a diagram showing an example of a program group and a management table group held by the program memory 350 in the first storage subsystem 300. The second storage subsystem 400, having the same configuration as described above, also includes the same program group and management table group.

The program memory 350 stores at least a management information input/output program 351, a page management program 352, a virtual volume management program 353, a tier control program 354, a data copy program 355, a logical volume management table 356, a page management table 357, a virtual volume management table 358, a tier management table 359, page-unit tier management map information 35a, and an IO monitor management table 35b.

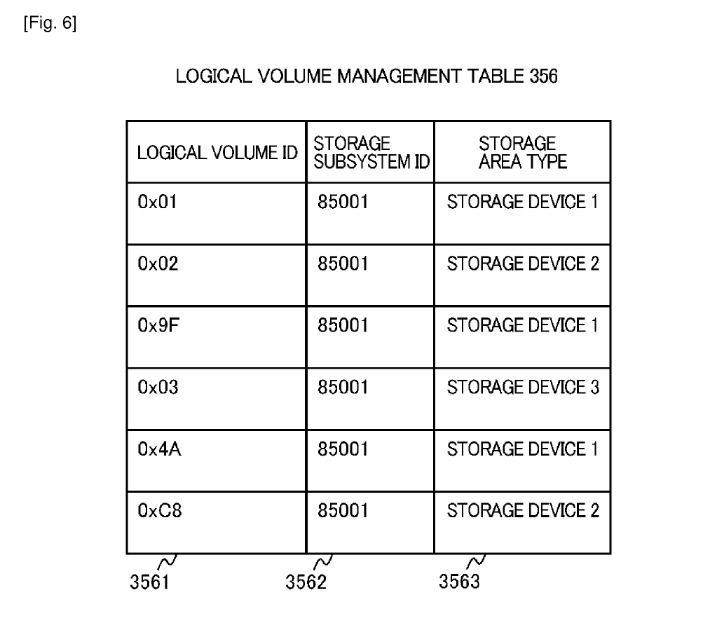

Hereinbelow, each of these programs stored in the program memory 350 will be described. Details of the group of various management tables stored in the program memory 350 will be described later with reference to FIG. 6 to FIG. 13.

The management information input/output program 351 transmits and receives management information between the first storage subsystem 300 and the management computer 200. In addition, the management information input/output program 351 transfers received management information to a program or a management table in the program memory 350. For example, when a data copy request is transmitted from the management computer 200, the management information input/output program 351 receives information on the data copy request, and transfers the information to the data copy program 355, which will be described later.

The page management program 352 is a program for managing the types of storage areas provided by the storage devices 370 and correlations between the logical volumes 371 and the pages 372, and updates the content of each of the various management tables in accordance with change in the configurations of the logical volumes 371, and the like.

For example, once a new logical volume 371 is created, the page management program 352 registers the logical volume ID, the ID of the first storage subsystem 300 to which the logical volume 371 belongs, and information on the type of the storage area that forms the logical volume 371. In this event, the page management program 352 updates the logical volume management table 356, which will be described later.

In addition, the page management program 352 manages information on the pages 372 included in the logical volumes 371. Specifically, the page management program 352 records management information in the page management table 357, which will be described later. The management information to be recorded here includes the logical volume ID, page IDs attached to pages belonging to the logical volume 371 as well as address information of each of the pages, the storage capacity, the allocation state to the virtual volume 373, and the like.

The virtual volume management program 353 creates the virtual volume 373 by using the pages 372 provided by the logical volumes 371 under the control of the tier control program 354 and the like, which will be described later. The virtual volume management program 353 also registers the state of the virtual volume 373 in the virtual volume management table 358.

The data copy program 355 performs a process of copying data stored in a designated page 372 to a designated page 372 in the first storage subsystem 300 or in the second storage subsystem 400.

The tier control program 354 manages tier information of the logical volumes 371, which is determined by the configurations of the storage devices 370 and the logical volumes 371, and the like, and performs a process of controlling the tiers of the pages 372 forming the virtual volume 373 on the basis of the tier information. Specifically, the tier control program 354 monitors performance information, such as the frequency of accesses to the pages 372 allocated to the virtual volume 373. Then, the tier control program 354 performs a process of migrating data stored in the page 372 determined to have a high access frequency into the page 372 on the logical volume 371 defined as a higher tier, and of migrating data stored in the page 372 determined to have a low access frequency into the page 372 on the logical volume 371 defined as a lower tier.

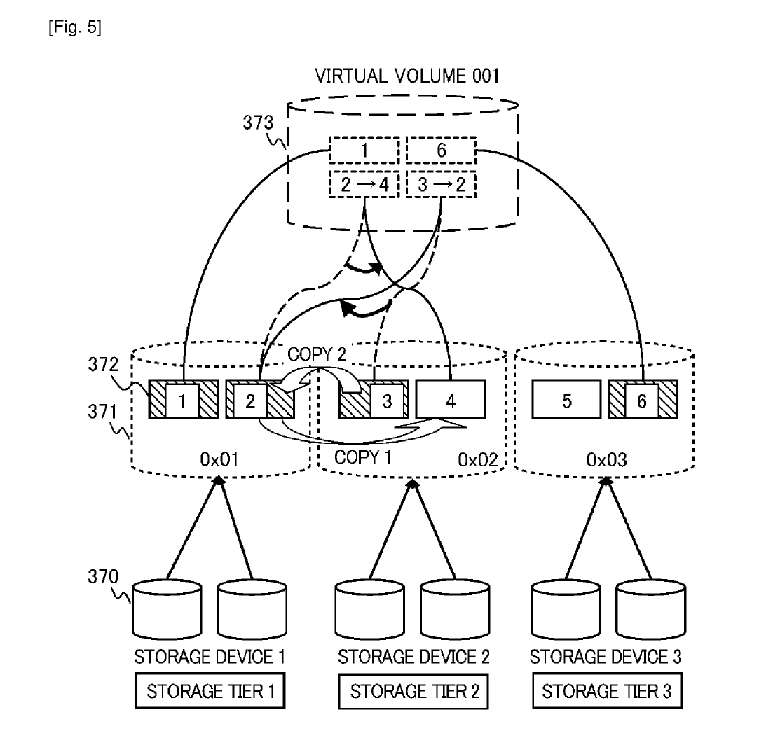

An example of the tier control performed by the tier control program 354 will be described with reference to FIG. 5. FIG. 5 shows an example of executing data migration in consideration of the tier structure on the virtual volume 001 (372) configured as shown in FIG. 3.

In FIG. 5, the tier control program 354 monitors performance information, such as the number of accesses in a certain period of time, on each of the pages 372 forming the virtual volume 373. Note that, in FIG. 5, the pages 372 with hatching have already been allocated to the virtual volume 373, while the pages 372 with no hatching have not yet been allocated to the virtual volume 373 and are thus available for use. Moreover, in the example shown in FIG. 5, storage tiers are characterized by the types of the storage devices 370, and the storage tiers are defined in such a manner that the storage device 1, the storage device 2, and the storage device 3 correspond to a storage tier 1, a storage tier 2, and a storage tier 3, respectively.

For example, consider a case where, as the result of the monitoring, the numbers of accesses in a certain period of time of the pages 372 represented by the page IDs “1, 2, 3, 6” in FIG. 5 are found to be “55, 30, 50, 10,” respectively. In this case, if the pages 372 are allocated in descending order of the number of access, the allocated order becomes “1, 3, 2, 6.” Accordingly, the pages 372 are determined to be allocated in this order from the highest tier. Specifically, data in the page 3 is determined to be migrated to a higher tier (the storage tier 1 in this example) than the page 2. However, in the example shown in FIG. 5, there is no available page in the storage tier 1. For this reason, data in the page 2 having a lower number of accesses than the page 3 does is first migrated (indicated by COPY 1 in FIG. 5) to a lower tier, and then, the data in the page 3 is migrated to the page 2 thus made available (indicated by COPY 2 in FIG. 5). With such a control, the page allocation according to the result of the monitoring the numbers of accesses is achieved.

Moreover, along with the data migration between the pages 372, the tier control program 354 updates information on the pages 372 forming the virtual volume 373, which is recorded in the virtual volume management table 358, as well as information on the allocation state of the pages 372, which is recorded in the page management table 357.

The series of tier control processes, including the monitoring of performance information, the determining of the storage tiers, and the data migration, as described above may only have to be executed at certain intervals, e.g., every 1 hour. In addition, the performance information is not limited to the number of accesses to each page, but may be other management information, such as the number of times of reading, the number of times of writing, the input/output operations per second (IOPS), the time elapsed from the last access, or the like.

Next, each of the management tables stored in the program memory 350 of the first storage subsystem 300 will be described.

FIG. 6 is a diagram showing an example of the logical volume management table 356. The logical volume management table 356 is a management table designed to manage the logical volumes 371, and stores at least information of a logical volume ID 3561, a storage subsystem ID 3562, and a storage area type 3563 (storage area characteristic information).

The logical volume ID 3561 is an ID attached for uniquely identifying each of the logical volumes 371. The storage subsystem ID 3562 is an ID of a storage subsystem to which the logical volume 371 belongs.

The storage area type 3563 is the type of a storage area forming the corresponding logical volume 371. In this example, as the storage area types, the types of the storage devices 370 are used. The type of the storage device 370 means the type which characterizes the performance of the storage device 370 in general, and examples of which include the type of storage media, such as SSD, SAS, SATA, or magnetic tapes, and the rotational speed of HDD. As this type, information which characterizes the logical configuration of the logical volume 371, such as RAID 5 and RAID 10, may alternatively be used, and the information used for the storage area type is not particularly limited in the description.

A first record in FIG. 6 shows, for example, that the logical volume “0x01” belongs to the storage subsystem “85001” and is configured of the “storage device 1.”

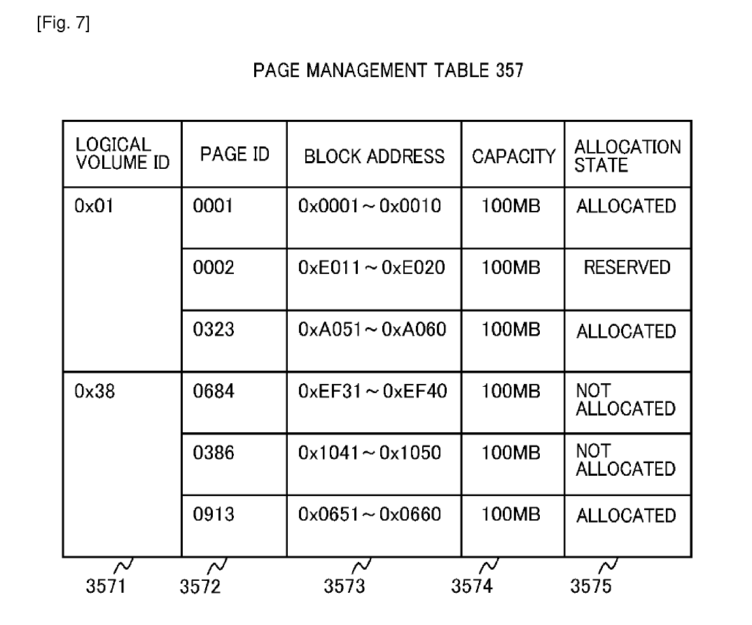

FIG. 7 is a diagram showing an example of the page management table 357. The page management table 357 is a management table designed to manage information on the pages 372 in the first storage subsystem 300, and stores at least information of a logical volume ID 3571, a page ID 3572, a block address 3573, a capacity 3574, and an allocation state 3575.

The logical volume ID 3571 is an ID for uniquely identifying each of the logical volumes 371 as in the logical volume management table 356.

The page ID 3572 is an ID for uniquely identifying each of the pages 372 forming the corresponding logical volume 371.

The block address 3573 is a block address or a range of the block addresses for a data block forming the corresponding page 372. The capacity 3574 is a storage capacity allocated to the corresponding page 372. The allocation state 3575 is an allocation state of the corresponding page 372 to the virtual volume 373. The state “ALLOCATED” indicates that the corresponding page 372 has already been allocated to the virtual volume 373, and the state “NOT ALLOCATED” indicates that the corresponding page 372 has not yet been allocated to any virtual volume 373. Further, the state “RESERVED” indicates that the corresponding page 372 has been reserved for the allocation to the virtual volume 373. If the allocation state 3575 is “RESERVED”, the corresponding page 372 cannot be allocated to the virtual volume 373 by any other programs and operations than the program that has made the reservation.

The example of the first record in FIG. 7 shows, for example, that the page “0001” belongs to the logical volume “0x01” and has an address range of “0x0001 to 0x0010.” In addition, the example shows that the corresponding page “0001” has a storage capacity of 100 MB and the allocation state thereof is that the page has already been allocated to a virtual volume.

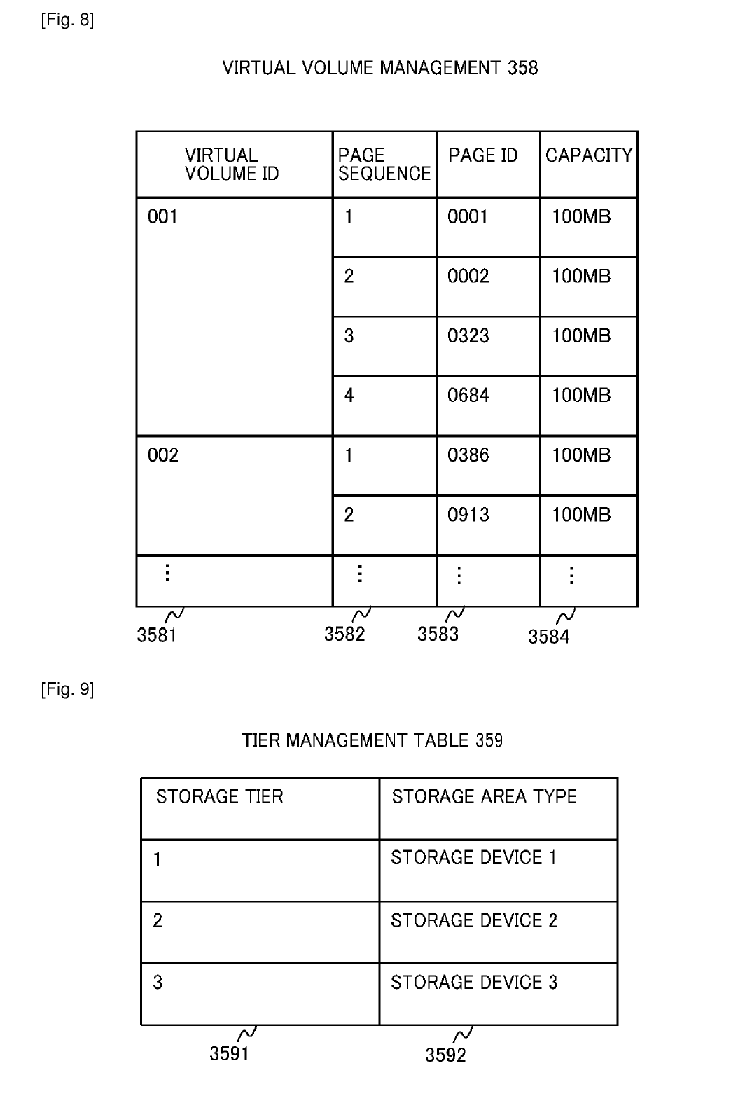

FIG. 8 is a diagram showing an example of the virtual volume management table 358. The virtual volume management table 358 is a management table designed to manage information on the virtual volume 373 and the pages 372 forming the virtual volume 373, and stores at least information of a virtual volume ID 3581, a page sequence 3582, a page ID 3583, and a capacity 3584.

The virtual volume ID 3581 is an ID for uniquely identifying the virtual volume 373. The page sequences 3582 are information indicating a relative positional relationship, in the virtual volume 373, of the pages 372 that form the virtual volume 373.

The page ID 3583 is an ID of each of the pages 372 allocated to the virtual volume 373. Note that the page ID 3583 herein is an ID that allows the corresponding page 372 to be uniquely identified in the storage system 1. The capacity 3584 is a storage capacity of the corresponding page 372.

The example in FIG. 8 shows, for example, that the page “0001” is allocated to the virtual volume “001”, and the storage capacity of the page “0001” is 100 MB.

FIG. 9 is a diagram showing an example of the tier management table 359. The tier management table 359 holds management information on the tiers of the storage areas in the first storage subsystem 300. The tier management table 359 stores at least information of a storage tier 3591 and a storage area type 3592.

The storage tier 3591 is a numerical value indicating the level of the storage tier. Although this example has only three tiers, four or more tiers may be provided. The storage area type 3592 is the type of a storage area associated with each of the storage tiers 3591, and is the same as that in the logical volume management table 356.

For example, the first record in FIG. 9 shows that the storage tier “1” belongs to a storage area formed of the “storage device 1.” In a general application of storage tiers, a storage area having a higher performance or reliability is used for a higher tier. In this example, it is assumed that the storage device 1 has the highest performance, then followed by the storage device 2 and the storage device 3 in this order.

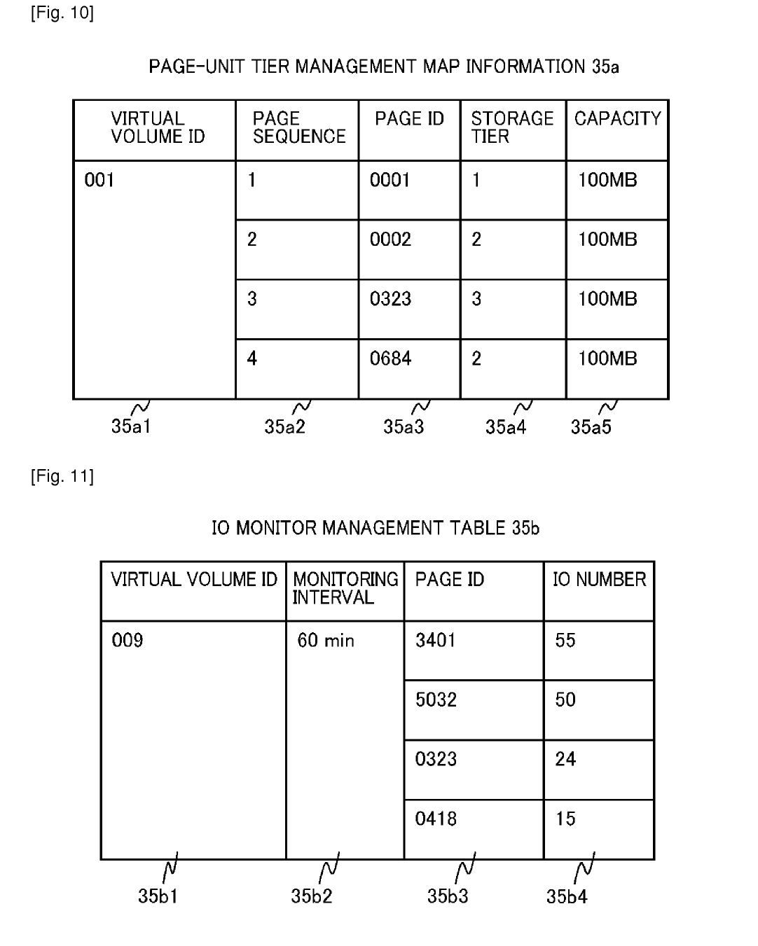

FIG. 10 is a diagram showing an example of the page-unit tier management map information 35a (storage area characteristic correspondence information). In this example, the page-unit tier management map information 35a is created by the first storage subsystem 300 in response to the execution of data migration as a trigger. The page-unit tier management map information 35a stores information on the page configuration and tier configuration of the virtual volume 373 that is designated as the migration target. The page-unit tier management map information 35a stores at least information of a virtual volume ID 35a1, a page sequence 35a2, a page ID 35a3, a storage tier 35a4, and a capacity 35a5 are stored.

The virtual volume ID 35a1 is an ID for uniquely identifying the virtual volume 373. The page sequences 35a2 are information indicating a relative positional relationship of the pages 372 that form the virtual volume 373. The page ID 35a3 is an ID of the page 372 allocated to the virtual volume 373. The storage tier 35a4 is a numerical value indicating the level of the storage tier. The capacity 35a5 is the storage capacity of the corresponding page 372.

FIG. 11 is a diagram showing an example of the IO monitor management table 35b. The IO monitor management table 35b stores the result of page-unit performance monitoring executed by the tier control program 354. The IO monitor management table 35b stores at least information of a virtual volume ID 35b1, a monitoring interval 35b2, a page ID 35b3, and an IO number 35b4.

The virtual volume ID 35b1 is the same as that in the above-described page-unit tier management map information 35a and the like. The monitoring interval 35b2 is a time interval at which the tier control program 354 monitors the performance information (60 minutes in the example in FIG. 11).

The page ID 35b3 is the same as that in the above-described page-unit tier management map information 35a and the like. The IO number 35b4 is the number of IOs with respect to the corresponding page 372 at the above-described monitoring interval 35b2. Note that the information (data characteristic information) monitored by the tier control program 354 is not limited to the IO number, but may be other information on the access state, such as the number of times of reading, the number of times of writing, the IOPS, the time elapsed from the last access, or the like.

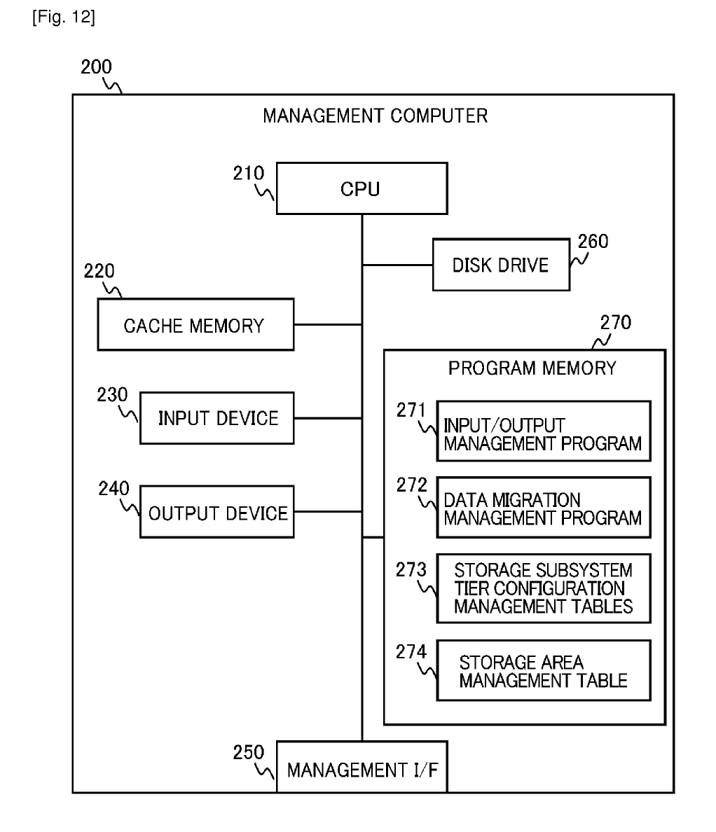

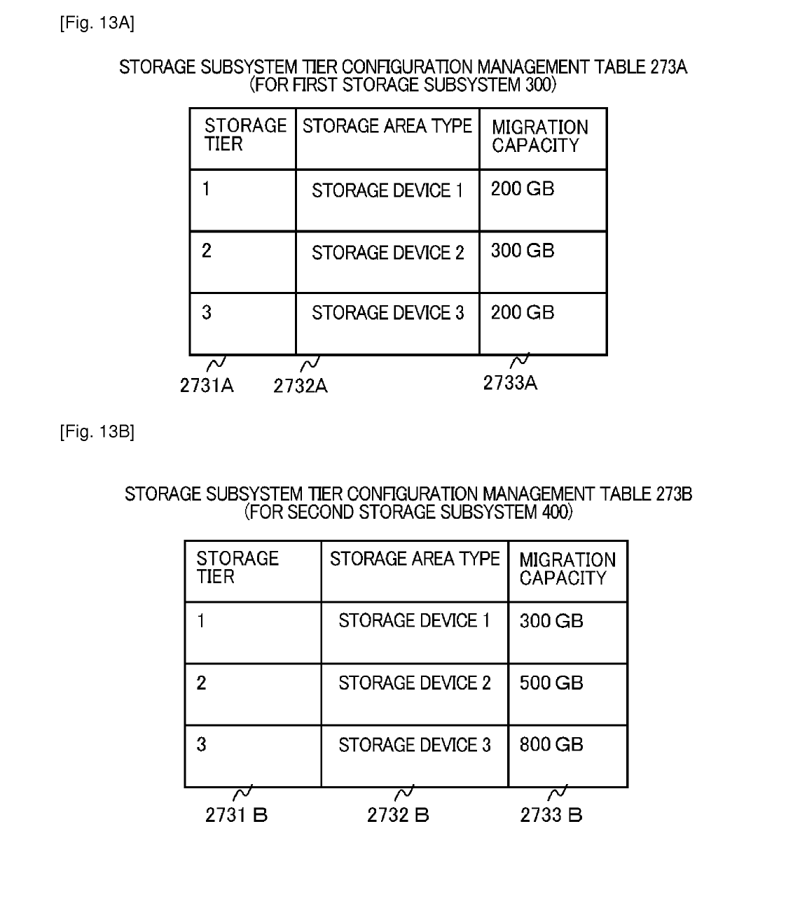

Next, the management computer 200 will be described. FIG. 12 is a diagram showing the internal configuration of the management computer 200 in terms of hardware.

The management computer 200 includes a CPU 210, a cache memory 220, an input device 230, an output device 240, a management interface 250, a disk drive 260, and a program memory 270, which are communicatively bus-connected to one another.

The hardware configuration of the management computer 200 may be the same as that of a general-purpose computer, such as a PC, for example. The cache memory 220 is a storage device, such as a RAM (Random Access Memory), provided for a temporary storage of data. For example, the input device 230 may be an input device such as a keyboard or a mouse, and the output device 240 may be a display device, such as a CRT (Cathode Ray Tube) or an LCD (Liquid Crystal Display), and a video output device.

Similarly, the management interface (I/F) 250 may be a general-purpose communication device such as the Ethernet (Registered Trademark). In addition, the program memory 270 may be a magnetic storage device or a data storage device formed of a semiconductor memory.

The program memory 270 is a storage device, such as a ROM (Read Only Memory) or a RAM, for example, and stores at least an input/output management program 271, a data migration management program 272, storage subsystem tier configuration management tables 273, and a storage area management table 274. Programs stored in the program memory 270 are executed by the CPU 210 reading the various programs and information from the program memory 270. The disk drive 260 is a secondary storage for data storage, such as a HDD, or may be configured of a semiconductor memory, such as an SSD.

Note that, the host computer 100 in FIG. 1 may also be one having the same hardware configuration as that of the above-described management computer 200. In this case, for example, application programs and the like to be used by the user on the host computer 100 are stored in a program memory of the host computer 100. In addition, the host computer 100 is provided with a data I/O I/F for managing the input and output of data to and from the first storage subsystem 300 and the second storage subsystem 400, instead of the management I/F 250 of the management computer 200.

Next, the programs stored in the program memory 270 will be sequentially described. First, the input/output management program 271 has a function to transmit and receive management information among the management computer 200, the first storage subsystem 300, and the second storage subsystem 400. In addition, the input/output management program 271 also has a function to transfer, to another program or a table in the program memory 270, the management information received from the first storage subsystem 300 and the second storage subsystem 400. In other words, the CPU 210 stores in the program memory 270 the management information received by executing the input/output management program 271, or uses the management information for executing another program.

The data migration management program 272 has a function to perform management regarding data migration processing between the first storage subsystem 300 and the second storage subsystem 400, and configures a data migration management part. The processing flow of this program will be described later with reference to related flowcharts.

Next, an example of the storage subsystem tier configuration management tables 273 will be described with reference to FIG. 13A and FIG. 13B. As illustrated in FIGS. 13A and 13B, the storage subsystem tier configuration management tables 273 include a storage subsystem tier configuration management table 273A for the first storage subsystem 300 and a storage subsystem tier configuration management table 273B for the second storage subsystem 400, in this example.

These storage subsystem tier configuration management tables 273A and 273B manage information on the configuration of a migration target volume in the first storage subsystem 300 and information on the configuration of a storage area available for the migration in the second storage subsystem 400. The storage subsystem tier configuration management table 273A for the first storage subsystem 300 stores at least information of a storage tier 2731A of the first storage subsystem 300, a storage area type 2732A of the first storage subsystem 300, and a migration capacity 2733A.

The storage tier 2731A of the first storage subsystem 300 is information indicating the level of a storage tier set in the first storage subsystem 300. The storage area type 2732A of the first storage subsystem 300 is information indicating the type of a storage area associated with the level of the corresponding storage tier, and is registered on the basis of information managed in the tier management table 359 in the first storage subsystem 300. The migration capacity 2733A is information indicating the capacity of each storage tier in the migration target volume to be migrated to the second storage subsystem 400.

The storage subsystem tier configuration management table 273B for the second storage subsystem 400 stores at least information of a storage tier 2731B of the second storage subsystem 400, a storage area type 2732B of the second storage subsystem 400, and a free capacity 2733B.

The storage tier 2731B of the second storage subsystem 400 is information indicating the level of a storage tier set in the second storage subsystem 400. The storage area type 2732B of the second storage subsystem 400 is information indicating the type of a storage area associated with the level of the corresponding storage tier, and is registered on the basis of information managed in the tier management table 359 in the second storage subsystem 400. The free capacity 2733B is information indicating the free capacity of each storage tier in the second storage subsystem 400.

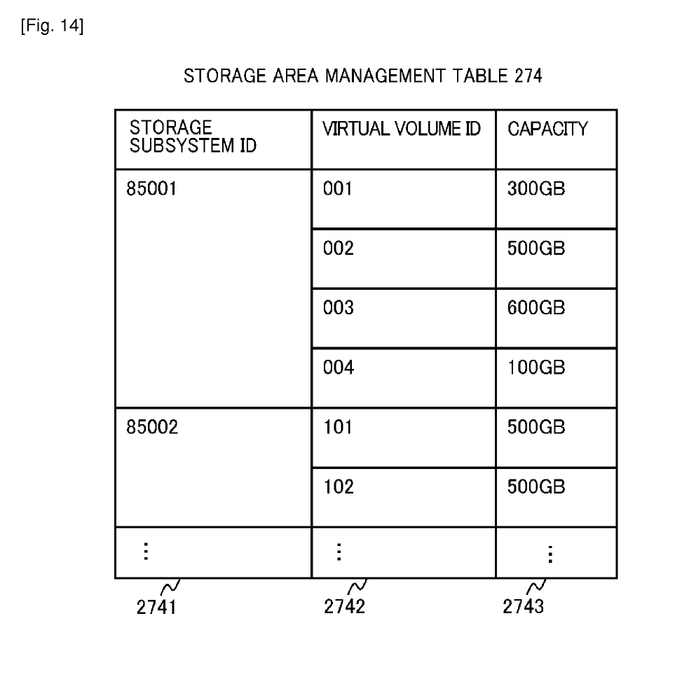

Next, the storage area management table 274 will be described. FIG. 14 shows an example of the storage area management table 274 of this example. The storage area management table 274 holds, for each storage subsystem, information in which the virtual volumes 373 provided in each storage subsystem and the storage capacities of the virtual volumes 373 are associated with each other.

In the storage area management table 274, a storage subsystem ID 2741 is an identification code that is information for uniquely identifying each storage subsystem, a virtual volume ID 2742 is an identification code that is information for uniquely identifying the virtual volume 373 belonging to the corresponding storage subsystem, and a capacity 2743 indicates the storage capacity of the virtual volume 373.

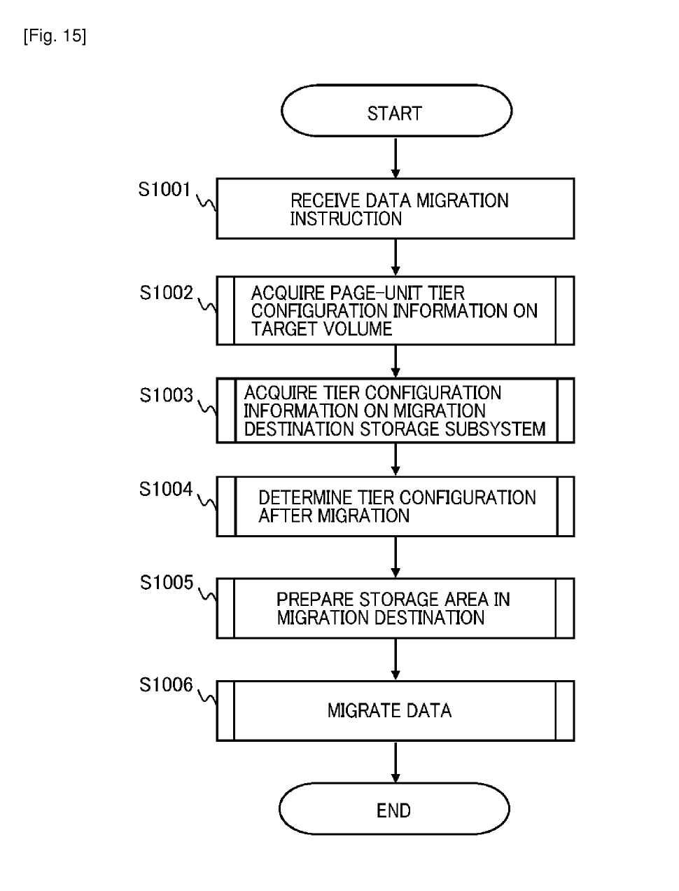

Next, the details of the data migration processing between storage subsystems in this example will be described. FIG. 15 is a flowchart showing an example of the processing flow of data migration performed by the data migration management program 272 installed in the management computer 200. Note that, the letter “S” of references given to the flowchart shown in FIG. 15 means a step, and this scheme is employed in the same manner through the present description. Moreover, who executes each of the processing steps is specified with the corresponding program; however, in the actual practice, a processing device, such as a CPU, corresponding to each of the programs executes the program, thereby implementing the corresponding processing step.

First of all, the data migration management program 272 receives a data migration instruction by the user from the host computer 100 or the input device 230 of the management computer 200 (S1001). This data migration instruction includes at least the ID of the first storage subsystem 300 to be the migration source of the data, the ID of the virtual volume to be the migration target in the first storage subsystem 300, and the ID of the second storage subsystem 400 to be the migration destination.

Next, the data migration management program 272 acquires page-unit tier configuration information of the migration target volume from the first storage subsystem 300 (S1002). The processing above will be described later.

Subsequently, the data migration management program 272 acquires tier configuration information from the second storage subsystem 400, which is to be the migration destination (S1003). The information to be acquired includes at least information on the storage tier configuration of the second storage subsystem 400 and the free capacity of each storage tier. The details of this processing will be described later.

Next, the data migration management program 272 determines the storage tier configuration of the virtual volume after migration (S1004). The details of the method for determining a storage tier configuration will be described later.

After the storage tier configuration after migration is determined, the data migration management program 272 requests the second storage subsystem 400, which is to be the migration destination, to prepare a storage area to be a migration destination (S1005). The details of this processing will be described later.

Once the preparation of the storage area is completed, the data migration management program 272 transmits a data migration processing request to the first storage subsystem 300 (S1006). The details of this processing will be described later.

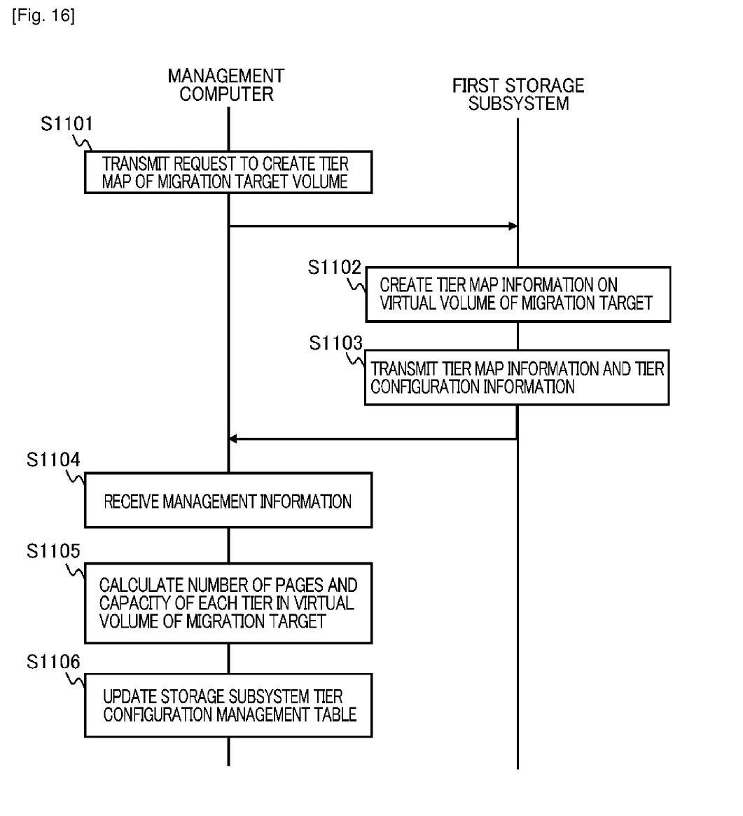

FIG. 16 shows an example of the detailed processing flow of the process of “acquiring the page-unit tier configuration information of the target volume” in S1002.

First, the data migration management program 272 transmits a request to create a tier map of a virtual volume 373, which is to be the migration target, to the first storage subsystem 300 (S1101). The request to create a tier map includes the IDs of one or multiple virtual volumes 373, which are to be the migration target.

Next, the virtual volume management program 353 in the first storage subsystem 300 refers to the virtual volume management table 358 and the tier management table 359, and creates the page-unit tier management map information 35a on the virtual volume 373 of the migration target (S1102).

Next, the virtual volume management program 353 transmits the page-unit tier management map information 35a thus created and the tier configuration information registered in the tier management table 359 to the management computer 200 (S1103).

The input/output management program 271 receives the page-unit tier management map information 35a and the tier configuration information, and transmits the information to the data migration management program 272 (S1104).

The data migration management program 272 calculates the number of pages and the capacity for each tier in the migration target virtual volume 373 from the page-unit tier management map information 35a thus received (S1105). For example, in the example shown in FIG. 10, the number of pages and the capacity of the storage tier 1 are calculated to be 1 and 100 MB, respectively, the number of pages and the capacity of the storage tier 2 are calculated to be 2 and 200 MB, respectively, and the number of pages and the capacity of the storage tier 3 are calculated to be 1 and 100 MB.

The data migration management program 272 updates the storage subsystem tier configuration management table 273A on the basis of the result of the calculation in S1105 (S1106).

With the above-described processing, it can be found out how much storage capacity is required in the migration destination storage system for each of the storage tiers of the migration target virtual volume 373.

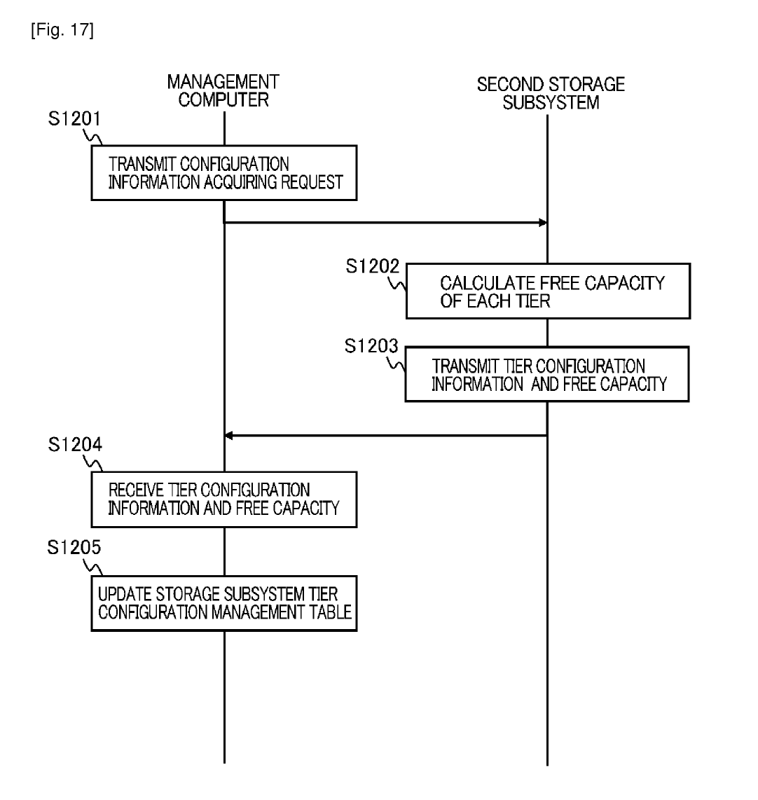

Next, the “process of acquiring tier configuration information on a migration destination storage subsystem” in S1003 will be described. FIG. 17 shows an example of the processing flow of the “process of acquiring tier configuration information on a migration destination storage subsystem.”

First, the data migration management program 272 in the management computer 200 transmits a configuration information acquiring request to the second storage subsystem 400 (S1201).

Upon receipt of the configuration information acquiring request, the second storage subsystem 400 calculates the free capacity of each tier (S1202). The free capacity of each tier can be calculated by referring to information on a “NOT ALLOCATED” area in the page management table 357, information on the types of storage areas in the logical volume management table 356, and the tier management table 359, in the second storage subsystem 400.

Next, the second storage subsystem 400 transmits the storage tier configuration and the free capacity of each tier, which is calculated in S1202, to the management computer 200 (S1203).

The input/output management program 271 in the management computer 200 receives the tier configuration and the free capacity of each tier from the second storage subsystem 400, and then transmits the storage tier configuration and the free capacity of each tier to the data migration management program 272 (S1204).

The data migration management program 272 updates the storage subsystem tier configuration management table 273B thereof on the basis of the information received in S1204 (S1205).

With the above-described processing, the storage capacity of each tier which can be secured in the migration destination storage subsystem can be acquired.

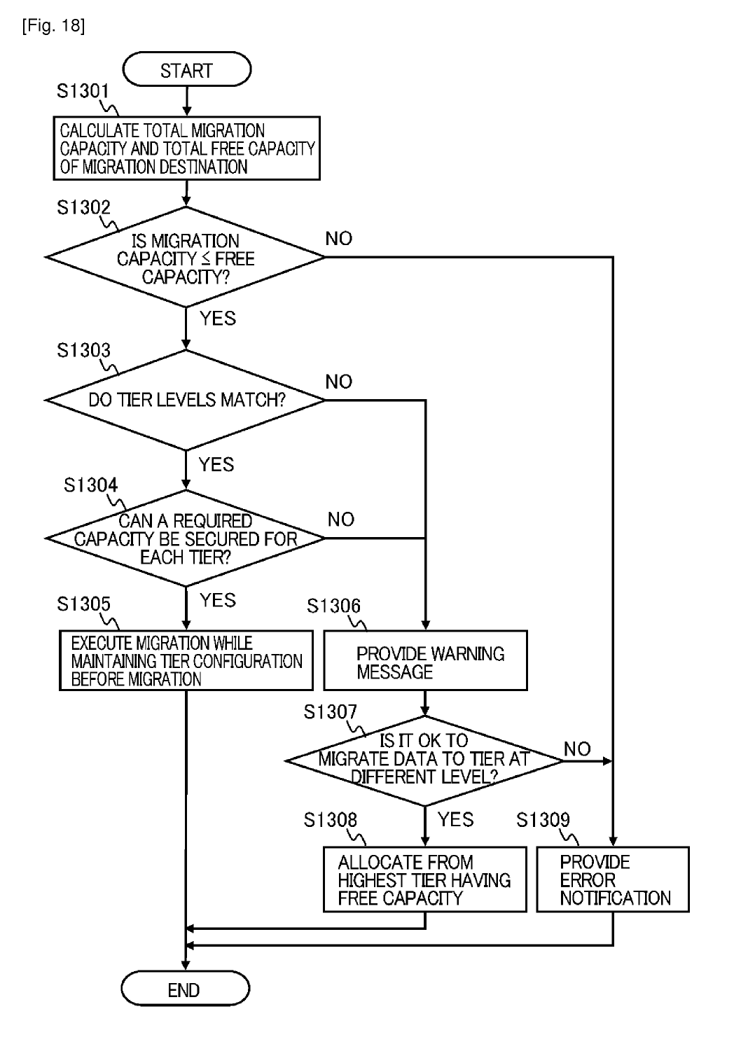

Next, the “process of determining the tier configuration after migration” in S1004 will be described. FIG. 18 shows an example of the detailed processing flow of the “process of determining the storage tier configuration after migration.”

First, the data migration management program 272 refers to information in the storage subsystem tier configuration management tables 273A and 273B, and thus calculates the total capacity of the migration target volume and the total free capacity of the migration destination (S1301).

The data migration management program 272 then compares the total capacity of the migration target volume and the total free capacity of the migration destination (S1302). When the data migration management program 272 determines that the total free capacity of the migration destination is not less than the total capacity of the migration target volume (Yes in S1302), the data migration management program 272 proceeds the processing to S1303. On the other hand, when the data migration management program 272 determines that the total free capacity of the migration destination is less than the total capacity of the migration target volume (No in S1302), the data migration management program 272 provides an error notification through the output device 240 or the like of the management computer 200 (S1309).

The data migration management program 272 refers to the storage subsystem tier configuration management tables 273A and 273B, and thus determines whether or not the tier configurations of the respective storage subsystems of the migration source and the migration destination match each other (S1303). When the data migration management program 272 determines that the tier configurations match each other (Yes in S1303), the data migration management program 272 proceeds the processing to S1304. On the other hand, when the data migration management program 272 determines that the tier configurations do not match each other (No in S1303), the data migration management program 272 proceeds the processing to S1306.

Subsequently, the data migration management program 272 refers to the storage subsystem tier configuration management tables 273A and 273B, and thus determines whether or not a capacity required for the migration can be secured for each tier (S1304). When the data migration management program 272 determines that the required capacity can be secured, that is, when the free capacity of each tier is not less than the capacity required for the migration (Yes in S1304), the data migration management program 272 proceeds the processing to S1305. On the other hand, when the data migration management program 272 determines that the free capacity of each tier is less than the capacity required for the migration (No in S1304), the data migration management program 272 proceeds the processing to S1306.

In S1305, the data migration management program 272 in the management computer 200 executes the data migration while maintaining the same tier configuration as that before the data migration.

In S1306, the data migration management program 272 provides a warning message through the output device 240 or the like. The warning message includes information requesting an instruction to continue the data migration, such as “Is Data Migration Continued Even Though Tier Configuration before Migration cannot be Maintained in Migration Destination?” The details of an example of the message output will be described later.

Subsequently, the data migration management program 272 determines whether or not an instruction to continue the data migration is inputted by the administrator in response to the notification made in S1306 (S1307). When the data migration management program 272 determines that the instruction is inputted by the administrator (Yes in S1307), the data migration management program 272 proceeds the processing to S1308. On the other hand, when the data migration management program 272 determines that no input is made by the administrator or when an instruction to stop the data migration is inputted by the administrator (No in S1307), the data migration management program 272 provides an error notification through the output device 240 or the like (S1309).

In S1308, the data migration management program 272 calculates the capacity of each tier in the migration destination in such a way as to allocate the total capacity of the migration target volume to the migration destination from the highest tier. For example, suppose a case where the total capacity in the migration target volume is 700 MB in which the capacities to be migrated of the respective tiers are “the storage tier 1: 200 MB, the storage tier 2: 300 MB, and the storage tier 3: 200 MB,” and the total free capacity in the migration destination is 1000 MB in which the free capacities of the respective tiers are “the storage tier 1: 100 MB, the storage tier 2: 300 MB, and the storage tier 3: 600 MB.” In this case, the data migration management program 272 can determine to migrate the data to a storage area of the total capacity of 700 MB including “100 MB of the storage tier 1, 300 MB of the storage tier 2, and 300 MB of the storage tier 3,” in the migration destination.

The above-described processing allows the administrator to determine what processing is executed when a capacity required for each tier cannot be secured in the migration destination. As a result of the processing, it is also possible for the administrator to execute the data migration from the highest storage tier having a free capacity in the migration destination.

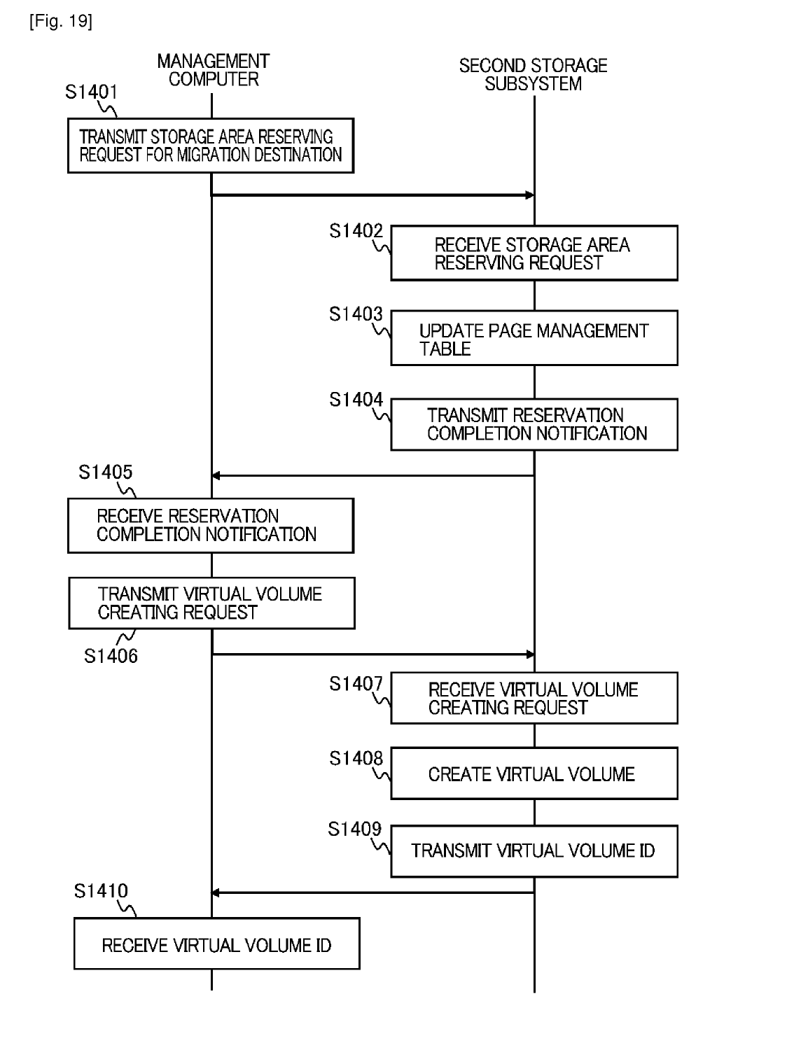

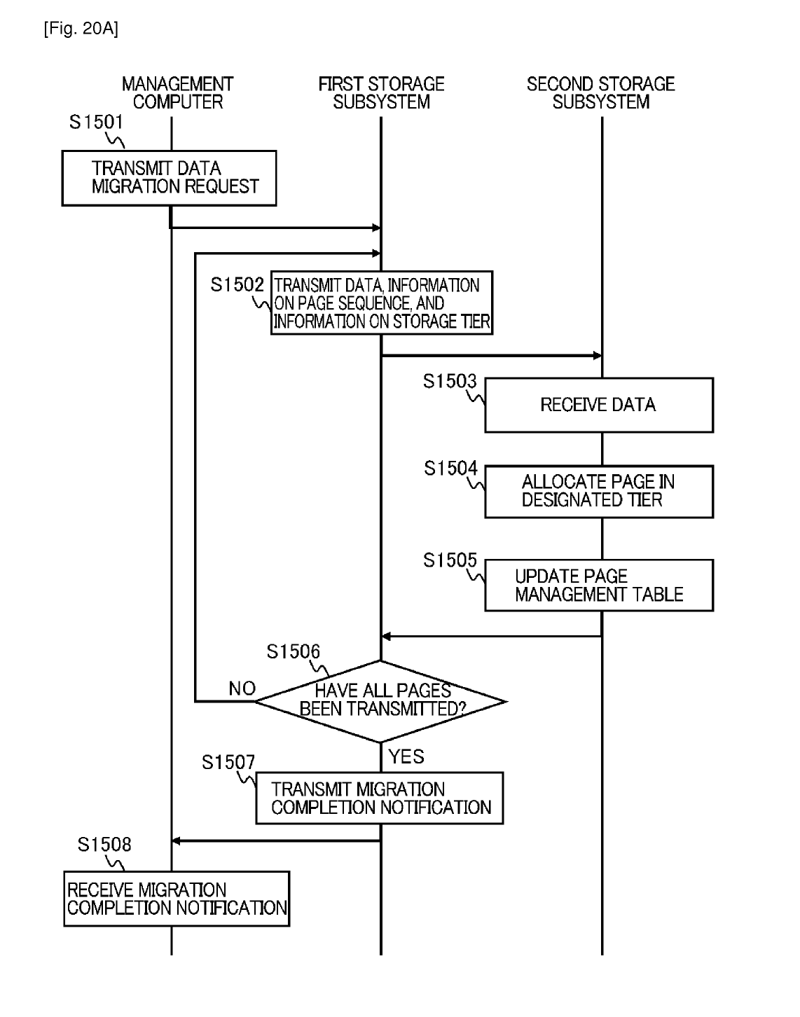

Next, the “process of preparing a storage area in the migration destination” in S1005 will be described. FIG. 19 shows an example of the detailed processing flow of the “process of preparing a storage area in the migration destination.”

First, the data migration management program 272 transmits a storage area reserving request to the second storage subsystem 400 on the basis of the tier configuration after migration determined in S1305 or S1308 in FIG. 18 (S1401). The storage area reserving request includes the capacity and the number of pages of each tier in the migration destination.

The second storage subsystem 400 receives the storage area reserving request, and transmits the storage area reserving request thus received to the page management program 352 (S1402).

The page management program 352 in the second storage subsystem 400 updates the page management table 357 on the basis of the reserving request thus received (S1403). Specifically, the page management program 352 updates the states of the pages in the “NOT ALLOCATED” state to “RESERVED” correspondingly to the number of pages or the capacity designated for each tier. Subsequently, the page management program 352 transmits a reservation completion notification to the management computer 200 (S1404).

The input/output management program 271 of the management computer 200 receives the reservation completion notification, and then transmits the reservation completion notification thus received to the data migration management program 272 (S1405).

After receiving the reservation completion notification, the data migration management program 272 transmits a request to create a virtual volume 373 that will be the migration destination to the second storage subsystem 400 (S1406).

The second storage subsystem 400 receives the virtual volume creating request, and transmits the virtual volume creating request thus received to the virtual volume management program 353 (S1407).

The virtual volume management program 353 creates a virtual volume 373, and updates the virtual volume management table 358 (S1408). In this process, the virtual volume management program 353 may allocate the pages 372 updated to be “RESERVED” in S1403 as pages for forming the virtual volume 373.

The second storage subsystem 400 transmits the ID of the virtual volume 373 thus created to the management computer 200 (S1409).

The input/output management program 271 of the management computer 200 receives the ID of the virtual volume 373 thus created, and then transmits the ID to the data migration management program 272 (S1410).

With the above-described processing, the virtual volume 373 having the storage tier configuration after migration, which is determined by the processing in FIG. 13, can be created in the storage subsystem of the migration destination.

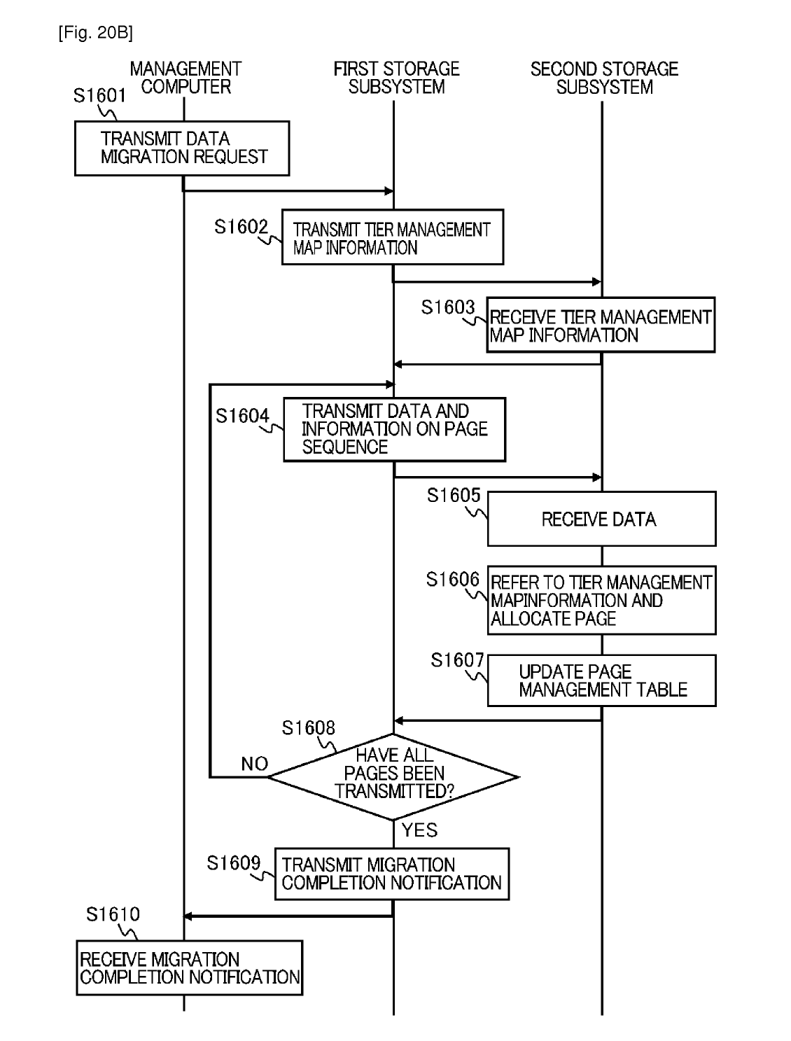

Next, the “data migration processing” in S1006 in FIG. 15 will be described. FIG. 20A shows an example of the detailed processing flow of the “data migration processing.”

Note that the methods for data migration include a method in which data is directly transmitted and received between storage subsystems and a method in which data is transmitted and received through the management computer 200. Furthermore, two kinds of methods can be conceived as the method for transmitting and receiving data between storage subsystems.

In FIG. 20A, one of the methods for directly transmitting and receiving data between storage subsystems will be described. In this method, when data is transmitted from the first storage subsystem 300 to the second storage subsystem 400, information on the storage tier of the migration destination is attached for each page. Then, the second storage subsystem 400 allocates a page from the designated storage tier in accordance with the attached information on the storage tier.

First, the data migration management program 272 in the management computer 200 transmits a data migration request to the first storage subsystem 300 (S1501). The data migration request includes at least the ID of the virtual volume 373 to be the migration target, the ID of the storage subsystem to be the migration destination, the ID of the virtual volume 373 to be the migration destination (the ID of the virtual volume 373 created in the second storage subsystem 400 in S1408), and information on the storage tiers in the migration destination (the number of pages and the capacity of each storage tier, and the like).

Upon receipt of the data migration request, the data copy program 355 in the first storage subsystem 300 transmits data stored in each of the pages forming the virtual volume 373 which is designated as the migration target, information on the page sequences of the pages, and information on the storage tiers of the migration destination, to the second storage subsystem 400 (S1502).

The second storage subsystem 400 receives data of each page and information on the storage tiers (S1503).

The virtual volume management program 353 in the second storage subsystem 400 stores the received data in a “RESERVED” page in the designated storage tier (S1504).

The virtual volume management program 353 in the second storage subsystem 400 updates the page management table 357 in terms of the page in which the data is stored in S1504, thereby changing the allocation state of the page from “RESERVED” to “ALLOCATED” (S1505). Then, the virtual volume management program 353 notifies the first storage subsystem 300 of the update and change.

The data copy program 355 in the first storage subsystem 300 repeats the processing from S1502 to S1505 until completing the transmission of all the pages (No in S1506). When the data copy program 355 determines that all the pages have been transmitted (Yes in S1506), the data copy program 355 in the first storage subsystem 300 transmits a data migration completion notification to the management computer 200 (S1507).

The management computer 200 receives the data migration completion notification from the first storage subsystem 300 (S1508).

With the above-described processing, direct data migration processing is executed to directly migrate data from the virtual volume 373 in the first storage subsystem 300, which is the migration source, to the virtual volume 373 in the second storage subsystem 400, which is the migration destination.

Next, a case where the “data migration processing” in S1006 in FIG. 15 is achieved by a different processing flow from that in FIG. 20A will be described. FIG. 20B shows an example of the detailed processing flow of the “data migration processing” achieved by the different processing flow.

In the processing flow in FIG. 20B, a method different from that shown in FIG. 20A will be described among the methods for directly transmitting and receiving data between storage subsystems. In this method, when data is transmitted from the first storage subsystem 300 to the second storage subsystem 400, tier management map information is transmitted from the first storage subsystem 300 to the second storage subsystem 400, and thereafter, page data is transmitted. In the second storage subsystem 400, pages are allocated to the storage tiers thereof in accordance with the tier management map information received at first.

First, the data migration management program 272 in the management computer 200 transmits a data migration request to the first storage subsystem 300 (S1601). The data migration request includes at least the ID of the virtual volume 373 to be the migration target, the ID of the storage subsystem to be the migration destination, the ID of the virtual volume 373 to be the migration destination (the ID of the virtual volume 373 created in S1408), and information on the storage tiers in the migration destination (the number of pages and the capacity of each storage tier, and the like).

Upon receipt of the data migration request, the data copy program 355 in the first storage subsystem 300 transmits the tier management map information 35a of the virtual volume 373 designated as the migration target to the second storage subsystem 400 (S1602). The second storage subsystem 400 receives the tier management map information 35a (S1603).

Subsequently, the data copy program 355 in the first storage subsystem 300 transmits data stored in each of the pages 372 forming the virtual volume 373 designated as the migration target and the information on the page sequences of the pages, to the second storage subsystem 400 (S1604).

The second storage subsystem 400 receives the data of each page and the page ID thereof (S1605).

The virtual volume management program 353 in the second storage subsystem 400 refers to the page-unit tier management map information 35a, and stores the received data in a “RESERVED” page of the storage tier designated in the tier management map information 35a (S1606).

The virtual volume management program 353 in the second storage subsystem 400 updates the page management table 357 in terms of the page in which data is stored in S1606, thereby changing the allocation state of the page from “RESERVED” to “ALLOCATED” (S1607).

The data copy program 355 in the first storage subsystem 300 repeats the processing from S1604 to S1607 until completing the transmission of all the pages (No in S1608). When the data copy program 355 determines that all the pages have been transmitted (Yes in S1608), the data copy program 355 in the first storage subsystem 300 transmits a data migration completion notification to the management computer 200 (S1609).

The management computer 200 receives the data migration completion notification from the first storage subsystem 300 (S1608).

With the above-described processing, direct data migration processing is executed to directly migrate data from the virtual volume 373 in the first storage subsystem 300, which is the migration source, to the virtual volume 373 in the second storage subsystem 400, which is the migration destination as in the case of the processing shown in FIG. 20A.

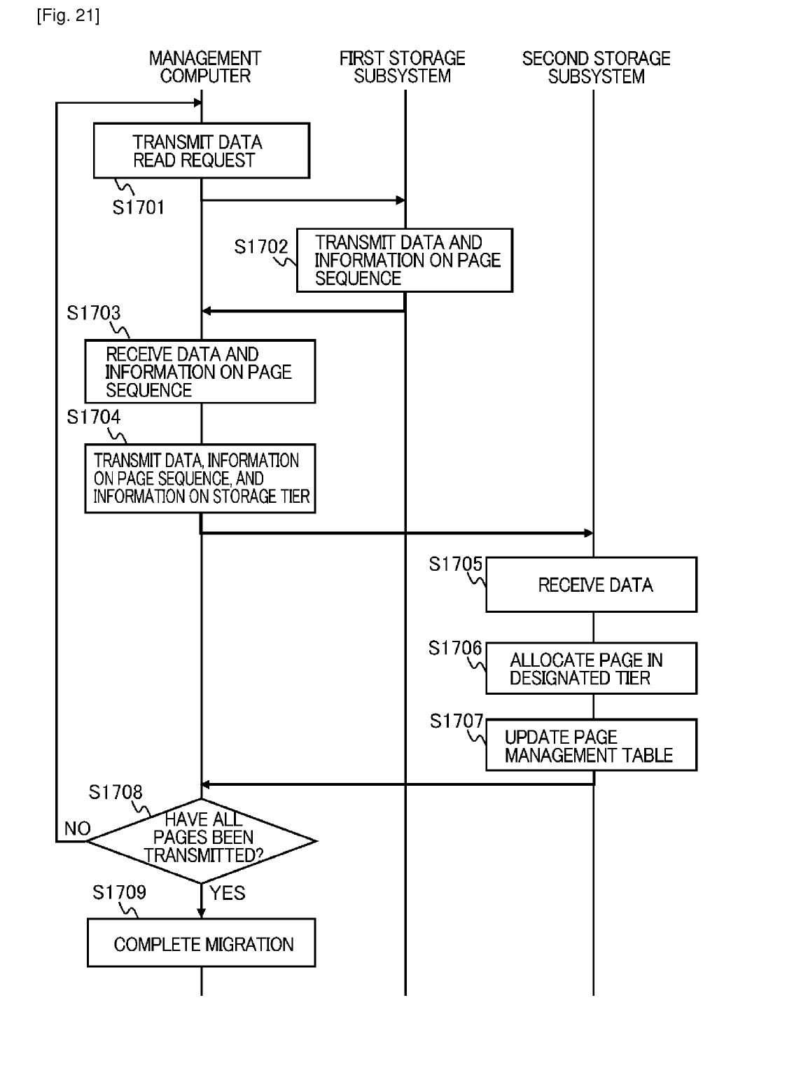

Next, a case where the “data migration processing” in S1006 in FIG. 15 is achieved by a different processing flow from those in FIG. 20A and FIG. 20B will be described. FIG. 21 shows an example of the detailed processing flow of the “data migration” in S1006 achieved by the further different processing flow.

This processing is a method for transmitting and receiving data between the first storage subsystem 300 and the second storage subsystem 400 through the management computer 200 among the methods for migrating data.

First, the data migration management program 272 in the management computer 200 issues a data read request to the first storage subsystem 300 (S1701). The data read request includes at least the ID of the virtual volume 373 to be the migration target.

Upon receipt of the data read request, the management information input/output program 351 in the first storage subsystem 300 refers to the page-unit tier management map information 35a, and then transmits data stored in each of the pages 372 forming the virtual volume 373 designated as the migration target and information on the page sequences of the pages, to the management computer 200 (S1702).

The management computer 200 receives the data of each page and the information on the page sequence thereof (S1703). The management computer 200 transmits data of each page and the information on the page sequence thereof while attaching thereto information on the storage tier to be allocated to the page in the migration destination storage subsystem obtained from the page-unit tier management map information 35a, to the second storage subsystem 400 (S1704).

The second storage subsystem 400 receives the data and management information transmitted from the management computer 200 (S1705).

The virtual volume management program 353 in the second storage subsystem 400 refers to the page-unit tier management map information 35a, and stores the received data in a “RESERVED” page in the storage tier designated in the tier management map information 35a (S1706).

The virtual volume management program 353 in the second storage subsystem 400 updates the page management table 357 in terms of the page in which the data is stored in S1706, thereby changing the allocation state of the page from “RESERVED” to “ALLOCATED.” (S1707).

The data migration management program 272 in the management computer 200 repeats the processing from S1701 to S1707 until completing the transmission of all the pages (No in S1708). When the data migration management program 272 determines that all the pages have been transmitted (Yes in S1708), the data migration is completed (S1709).

With the above-described processing, the data migration processing is executed to migrate data from the virtual volume 373 in the first storage subsystem 300, which is the migration source, to the virtual volume 373 in the second storage subsystem 400, which is the migration destination through the management computer 200, as in the cases of the processing shown in FIG. 20A and FIG. 20B.

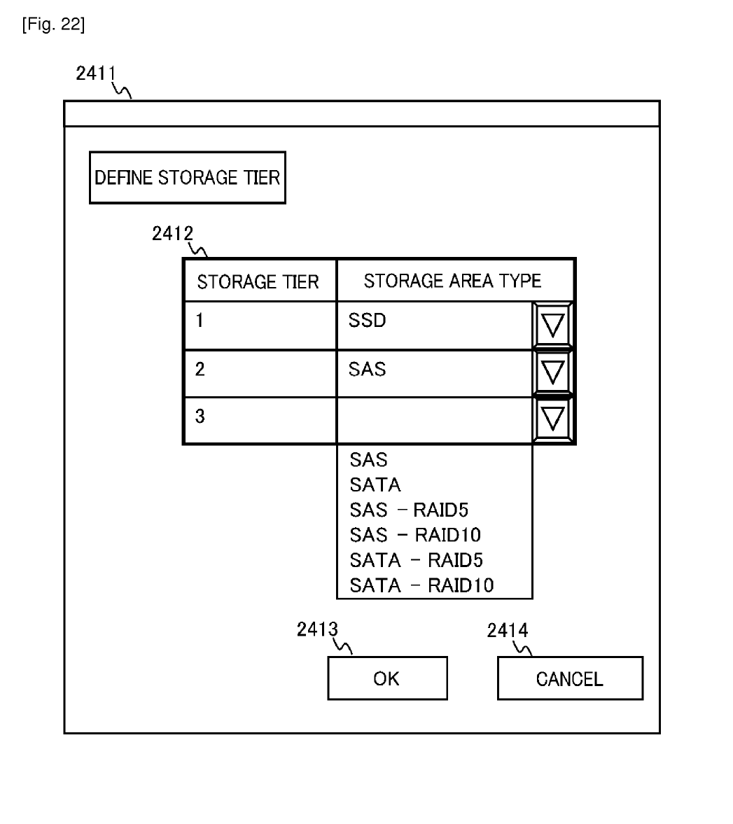

FIG. 22 shows an example of a management screen allowing the administrator to define a storage tier. The management screen shown in FIG. 22 can be created, for example, by the input/output management program 271 in the management computer 200.

A management screen 2411 used by the administrator to execute the defining of a storage tier (the associating of a storage tier with the type of a storage device providing a storage area forming the storage tier) is displayed on a monitor screen of the output device 240 of the management computer 200, for example. The management screen 2411 includes at least a tier defining part 2412, a confirmation button 2413, and a cancel button 2414. The confirmation button 2413 and the cancel button 2414 have functions in a general GUI screen.

The tier defining part 2412 allows the administrator to specify the level of a storage tier and the type of a storage area to be associated with each of the levels of storage tiers. As the type of a storage area, the type of a storage device (an SSD, an HDD, or the like) included in the storage subsystem, the RAID level configured in the storage subsystem, or the like is displayed, and the display may have the form in which the type is selected through a pull-down menu or the like.

The management screen 2411 allows the administrator to set a storage device of an appropriate type to be allocated to each storage tier.

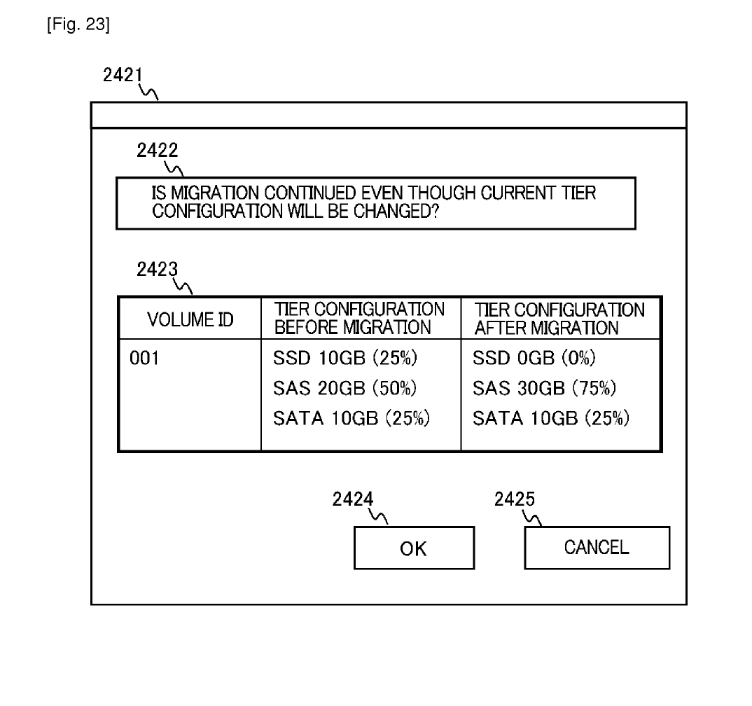

FIG. 23 shows an example of the warning message and a management screen outputted in S1306, which has been described in FIG. 18. The management screen shown in FIG. 23 can be created, for example, by the input/output management program 271 in the management computer 200.

A management screen 2421 includes at least a warning message 2422, a display part 2423 for displaying information on tier configurations before and after migration in the migration target volume, a confirmation button 2424, and a cancel button 2425. The warning message includes information requesting an instruction to continue the data migration, such as “Is Data Migration Continued Even Though Tier Configuration before Migration cannot be Maintained in Migration Destination?”

### Example 2

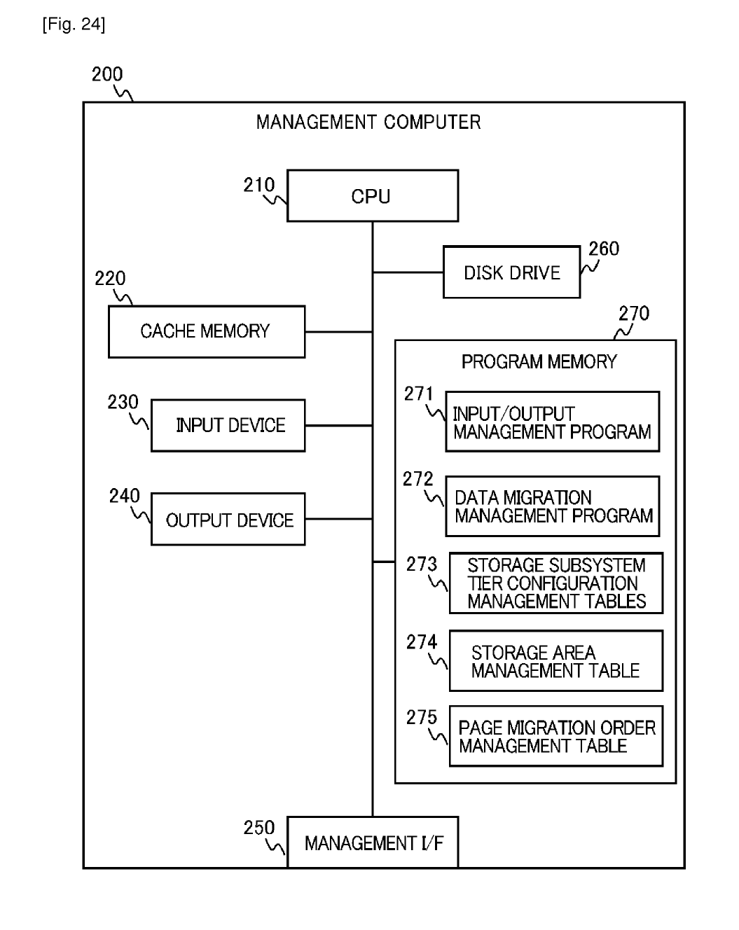

Next, a storage system 1 according to Example 2 of the present invention will be described. The coupling configuration of the storage system 1 in Example 2 is the same as that shown in FIG. 1. FIG. 24 shows an example of an internal configuration of a management computer 200 in Example 2. The management computer 200 in Example 2 is different, from that in Example 1, in that the management computer 200 includes a page migration order management table 275 in the program memory 270. Meanwhile, the internal configurations of the management computer 200, the first storage subsystem 300, and the second storage subsystem 400 are all the same as those in Example 1.

Moreover, the details of the processing of the various programs and the contents of the various management tables are the same as those in Example 1 except for those to be particularly described below.

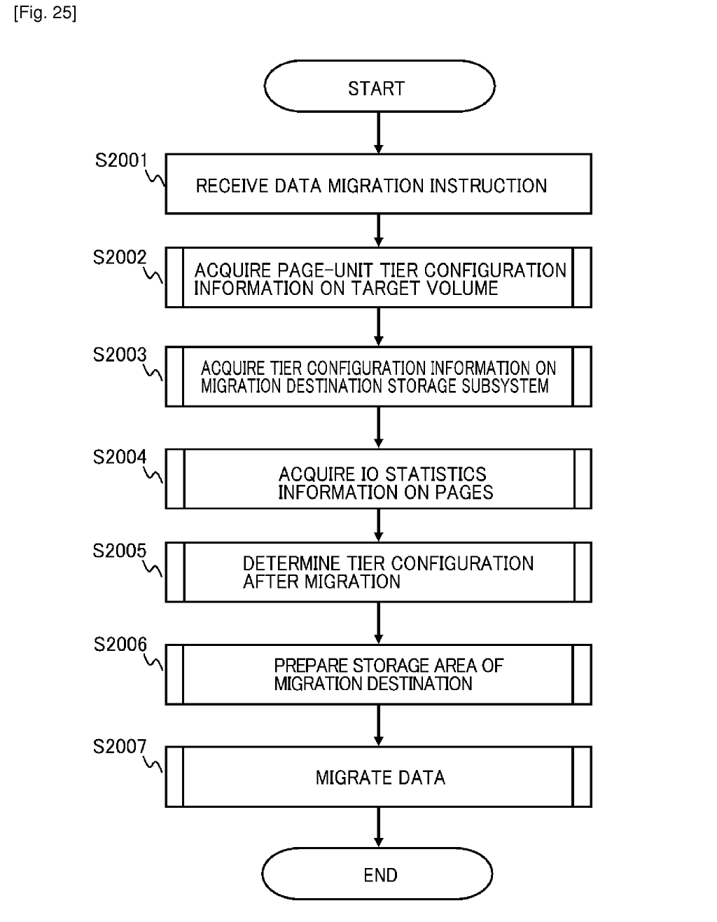

First, data migration processing performed by the management computer 200 in Example 2 will be described. FIG. 25 shows an example of the processing flow of data migration executed by the data migration management program 272 in the management computer 200. The processing flow corresponds to the processing flow shown in FIG. 15 of Example 1.

First, the data migration management program 272 in the management computer 200 receives a data migration instruction made by the user through the input device 230 or the like of the management computer 200 (S2001). The data migration instruction includes at least the ID of the first storage subsystem 300 to be the migration source of the data, the ID of the virtual volume 373 to be the migration target in the first storage subsystem 300, and the ID of the second storage subsystem 400 to be the migration destination.

The data migration management program 272 acquires information on the configuration of the target volume and information on the storage tier configuration thereof from the first storage subsystem 300, which is the migration source storage subsystem (S2002). The detailed processing flow of collecting the configuration information may be the same as that in S1002 in Example 1.

Subsequently, the data migration management program 272 acquires configuration information from the second storage subsystem 400 to be the migration destination (S2003). The information to be collected includes information on the storage tiers of the second storage subsystem 400, the free capacity of each storage tier, information on the types of storage areas, and the like. The processing flow in S2003 may be the same as that in S1003 in Example 1. It should be noted, however, that, in Example 2, the information on the types of storage areas includes information used for determining the performances of storage areas (for example, the rotational speeds of storage devices as will be described later).

The data migration management program 272 acquires IO statistics information on the migration target volume from the first storage subsystem 300 (S2004). The IO statistics information is information on IO frequency monitored for each of the pages 372 forming the migration target volume, and is information monitored by the tier control program 354 in the first storage subsystem 300. The detailed processing flow of collecting the IO statistics information will be described later.

Next, the data migration management program 272 determines a storage tier configuration of the virtual volume 373 after migration (S2005). The details of the method for determining the storage tier configuration will be described later.

After the storage tier configuration after migration is determined, the data migration management program 272 requests the second storage subsystem 400, which is to be the migration destination, to prepare a storage area to be the migration destination (S2006). The details of this processing will be described later.

Once the preparation of the storage area is completed, the data migration management program 272 transmits a data migration processing request (S2007). The details of this processing will be described later.

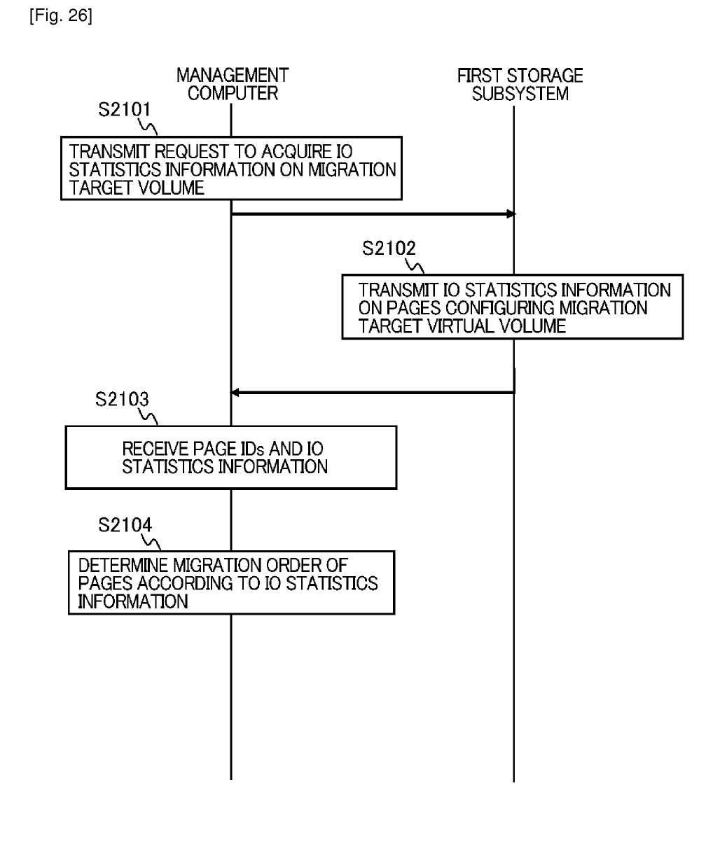

Next, the “process of acquiring IO statistics information on a page” in S2004 in FIG. 25 will be described. FIG. 26 shows an example of the detailed processing flow of the “process of acquiring IO statistics information on a page.”

First, the data migration management program 272 transmits a request to acquire IO statistics information on a virtual volume to be the migration target, to the first storage subsystem 300 (S2101). The request to acquire IO statistics information includes the IDs of one or multiple virtual volumes to be the migration targets.

The tier control program 354 in the first storage subsystem 300 transmits the IO statistics information on the target volume to the management computer 200 in response to the request to acquire IO statistics information (S2102). The IO statistics information is information on the IO frequency monitored for each of the pages 372 forming the migration target volume, and may be information managed in the IO monitor management table 35b shown in FIG. 11 in Example 1.

The input/output management program 271 receives the page-unit IO statistics information, and then transmits the page-unit IO statistics information thus received to the data migration management program 272 (S2103).

The data migration management program 272 determines a migration order of pages on the basis of the IO statistics information received from each of the first storage subsystem 300 and the second storage subsystem 400 (S2104). The migration order of pages is determined on the basis of the IO statistics information, and is defined, in this example, as a descending order of the number of IOs in a predetermined period of time.

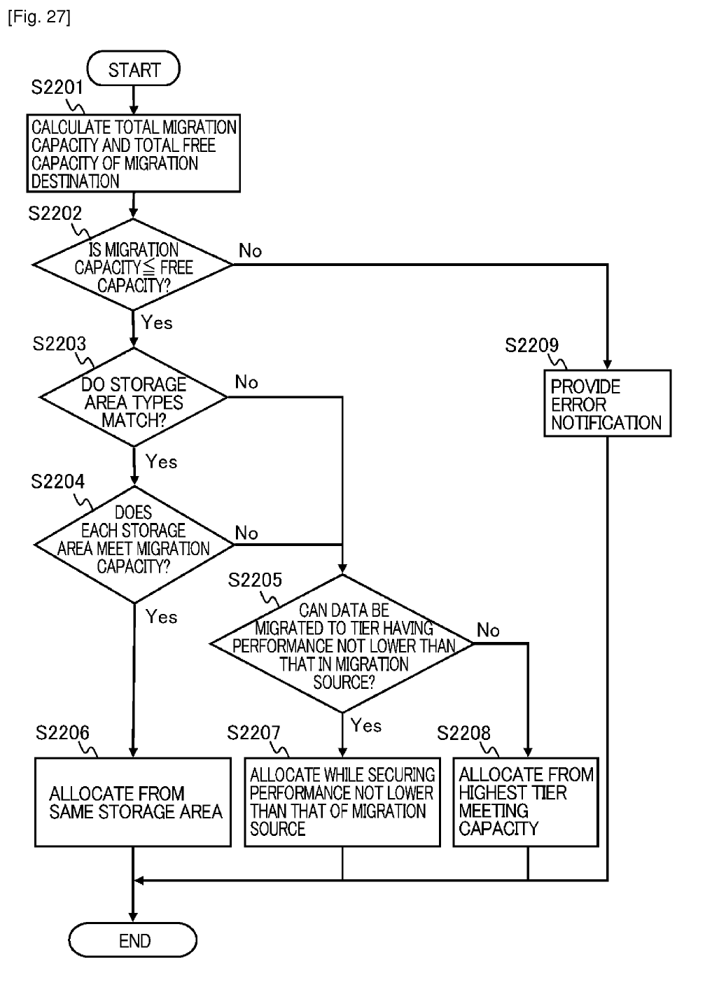

Next, the “process of determining a storage tier configuration after migration” in S2005 in FIG. 25 will be described. FIG. 27 shows an example of the detailed processing flow of the “process of determining a storage tier configuration after migration.”

The data migration management program 272 refers to information in the storage subsystem tier configuration management tables 273A and 273B, and thus calculates the total capacity of the migration target volume and the total free capacity of the migration destination (S2201).

The data migration management program 272 determines whether the total free capacity of the migration destination is not less than the total capacity of the migration target volume (S2202). When the data migration management program 272 determines that the total free capacity of the migration destination is not less than the total capacity of the migration target volume (Yes in S2202), the data migration management program 272 proceeds the processing to S2203. On the other hand, when the data migration management program 272 determines that the total free capacity of the migration destination is less than the total capacity of the migration target volume (No in S2202), the data migration management program 272 provides an error notification through the output device 240 or the like of the management computer 200 (S2209).

In S2203, the data migration management program 272 refers to the storage subsystem tier configuration management tables 273, and thus determines whether or not the types of storage areas of the migration source and the migration destination match each other (S2203). When the data migration management program 272 determines that the types of storage areas of the migration source and the migration destination match each other (Yes in S2203), the data migration management program 272 proceeds the processing to S2204. On the other hand, when the data migration management program 272 determines that the types of storage areas do not match each other (No in S2203), the data migration management program 272 proceeds the processing to S2205.

Note that there is no necessity here that the levels of storage tiers match each other. Even if the levels of storage tiers are different from each other, what is necessary is only that the same types of storage areas as those of the storage areas before migration are present in the migration destination storage subsystem.

In S2204, the data migration management program 272 determines, for each of the types of storage areas determined to match in S2203, whether or not a capacity necessary for the migration can be secured, in other words, determines, for the storage area, whether the free capacity in each storage area is not less than the migration capacity (S2204). When the data migration management program 272 determines that the free capacity is not less than the migration capacity for each storage area (Yes in S2204), the data migration management program 272 proceeds the processing to S2206. On the other hand, when the data migration management program 272 determines that the free capacity is less than the migration capacity for each storage area (No in S2204), the data migration management program 272 proceeds the processing to S2205.

In S2206, the data migration management program 272 in the management computer 200 determines to allocate each storage area to the same storage area as that before the data migration, in the second storage subsystem 400 of the migration destination. In other words, the data migration management program 272 allocates, for each storage area before migration, the same amount of capacity of the corresponding storage area of the migration destination as that of the migration capacity corresponding to the storage area.

In S2205, the data migration management program 272 refers to information on the performance of the storage area in the storage subsystem tier configuration management tables 273, and thus determines whether or not a storage area having a performance not lower than that of the corresponding storage area before migration can be secured in the migration destination storage subsystem. An example of the information on the performance of the storage area is the rotational speed of a storage device. When the data migration management program 272 determines that a storage area having a performance not lower than that of the corresponding storage area before migration can be secured (Yes in S2205), the data migration management program 272 proceeds the processing to S2207. On the other hand, when the data migration management program 272 determines that a storage area having a performance not lower than that of the corresponding storage area before migration cannot be secured (No in S2205), the data migration management program 272 proceeds the processing to S2208. The case where the performance not lower than that before migration cannot be secured may be a case where the performances of all the storage areas in the migration destination storage subsystem are lower than those of the corresponding storage areas before migration, or a case where there is no sufficient capacities for securing the performance not lower than that before migration.

In S2207, the data migration management program 272 determines to allocate the storage areas from a lower tier in the second storage subsystem 400 of the migration destination while securing the performance not lower than the performance of the migration source.

In S2208, the data migration management program 272 determines to allocate the storage areas from a higher tier in the second storage subsystem 400 of the migration destination while securing the migration capacity.

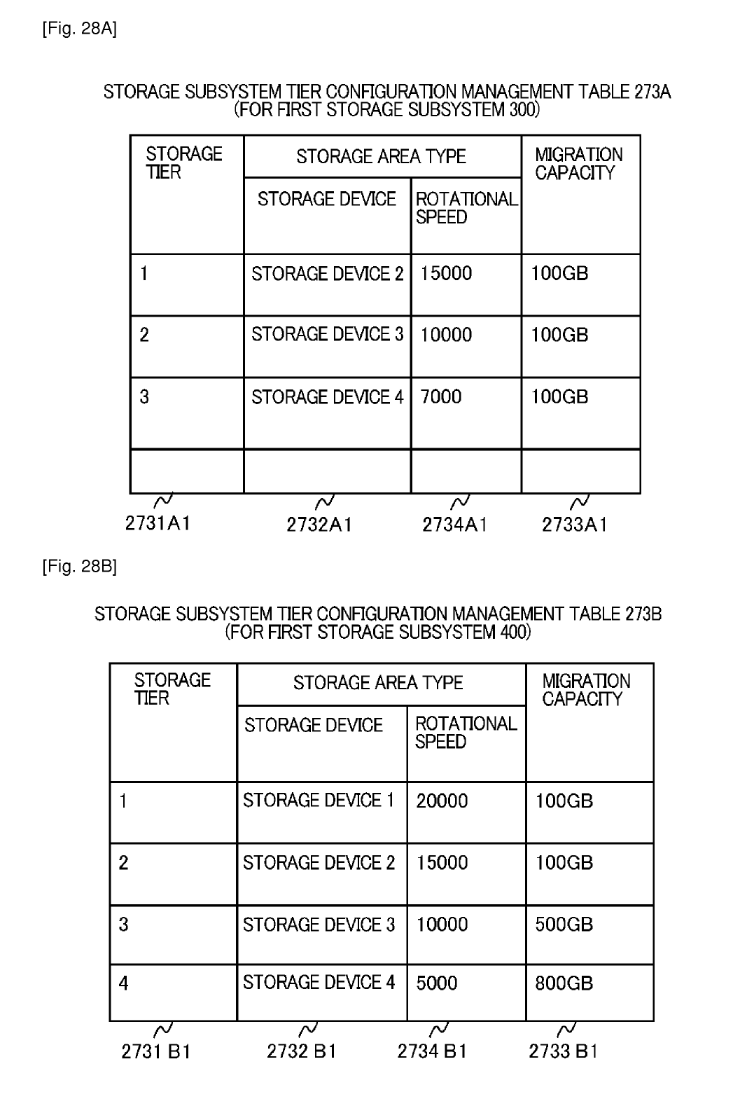

Here, a method for determining the tier configuration after migration will be described by giving a specific example shown in FIG. 28A and FIG. 28B. FIG. 28A and FIG. 28B correspond respectively to the storage subsystem tier configuration management tables 273A and 273B shown in FIGS. 13A and 13B. However, FIG. 28A and FIG. 28B are different from FIG. 13A and FIG. 13B in that a storage-device rotational speed 2734A1 or 2734B1 is specified in association with the corresponding storage device 2732A1 or 2732B1 for each of the storage tiers 2731A1 and 2731B1.

In the example shown in FIG. 28A and FIG. 28B, the capacity of migration targets is 300 GB in total, and the free capacity of storage areas in the migration destination is 1500 GB in total. Accordingly, it is found that the migration is possible because the migration capacity is smaller than the free capacity (S2202 in FIG. 27).

Next, when the storage area types of the migration source and the migration destination are referred. The storage tiers 1 and 2 before migration match the storage tiers 2 and 3 in the migration destination; however, the storage tier 3 before migration does not match any of the storage areas in the migration destination (No in S2203 in FIG. 27)

Subsequently, the information on the performances of the storage areas in the migration source and the migration destination are referred. While the rotational speed of the storage tier 3 before migration is 7000, the rotational speeds of the storage tiers 4 and 3 in the migration destination are 5000 and 10000, respectively. For this reason, it is determined that the data of 100 GB in the storage tier 3 before migration should be allocated first to the storage tier 3 or higher in the migration destination. In this respect, if calculated, the free capacity of the storage tier 3 and higher in the migration destination is 700 GB, and the migration capacity of the storage tier 3 and higher in the migration source is 300 GB. Accordingly, it is found that the migration is possible with the performances maintained.

Similarly, the performance of the storage tier 2 before migration is 10000. Among the storage areas in the migration source, storage areas having performance equal to or higher than that of the storage tier 2 before migration are the storage tier 3 and higher. The rest of the migration capacity of the migration source, excluding 100 GB of the storage tier 3 for which the migration destination has first been determined, is 200 GB, while the capacity from which 100 GB is subtracted of the storage tier 3 in the migration destination is 400 GB. Accordingly, it is found that the data in the storage tier 2 in the migration source can also be migrated to the storage tier 3 in the migration destination. Similarly, when the migration destination for the storage tier 1 in the migration source is determined, it is determined that the data in the storage tier 1 in the migration source can be migrated to the storage tier 2 in the migration destination.

Accordingly, in this example, the storage areas in the migration destination are allocated while performance not lower than that of the migration source as in S2207 in FIG. 27 is secured.

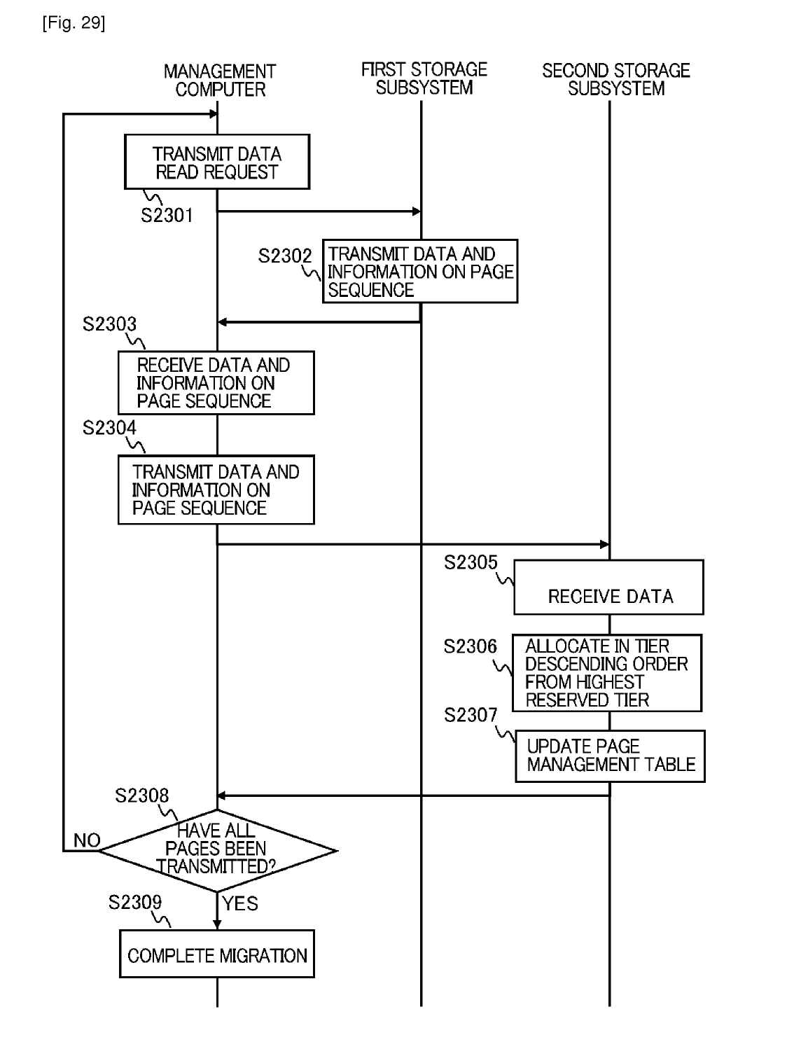

Next, the “data migration processing” in S2007 in FIG. 25 will be described. FIG. 29 shows an example of the detailed processing flow of the “data migration processing.”

This process uses a method for transmitting and receiving data between the first storage subsystem 300 and the second storage subsystem 400 through the management computer 200, among the methods for data migration.

First, the data migration management program 272 in the management computer 200 issues a data read request to the first storage subsystem 300 (S2301). The data read request includes the page ID. At this time, the data migration management program 272 issues the data read request in accordance with the migration order determined in S2104 in FIG. 26.

Upon receipt of the data read request, the management information input/output program 351 in the first storage subsystem 300 refers to the page-unit tier management map information 35a, and transmits data stored in each of the pages 372 forming the virtual volume 373 designated as the migration target, and the information on the page sequence thereof, to the management computer 200 (S2302).

The management computer 200 receives the data and the information on the page sequence of each page 372 from the first storage subsystem 300 (S2303), and transmits the data and the information on the page sequence of each page 372 to the second storage subsystem 400 (S2304).

The second storage subsystem 400 receives the data and the information on the page sequence transmitted from the management computer 200 (S2305).

The virtual volume management program 353 in the second storage subsystem 400 allocate the data thus received to the “RESERVED” storage areas in descending order from the highest tier (S2306). The virtual volume management program 353 in the second storage subsystem 400 updates the page management table 357 in terms of the pages 372 in which the data is stored in S2306, thereby changing the allocation state of the page from “RESERVED” to “ALLOCATED” (S2307). Then, the virtual volume management program 353 notifies the management computer 200 of the update and change.

Subsequently, the data migration management program 272 in the management computer 200 repeats the processing from S2301 to S2307 until completing the transmission of all the pages (No in S2308). When the data migration management program 272 determines that all the pages have been transmitted (Yes in S2308), the data migration is completed (S2309).

With the above-described processing, the data migration from the first storage subsystem 300 to the second storage subsystem 400 can be executed while the performance relations, such as the rotational speed of a storage device, which is required for each of the storage tiers are maintained.

### Example 3

Next, a storage system 1 according to Example 3 of the present invention will be described. In Example 3, the following case will be described. Specifically, it is supposed that there is an existing virtual volume in a storage subsystem of the migration destination. When data has been stored in the existing virtual volume, a priority order is determined for the existing data in the migration destination and data of the migration target, and thus, storage tiers after migration are configured.

Note that, the coupling configuration of the storage system 1 in Example 3 is the same as that shown in FIG. 1. In addition, the internal configurations of the management computer 200, the first storage subsystem 300, and the second storage subsystem 400 are all the same as those in Example 1.

Moreover, the details of the processing of the various programs and the contents of the various management tables are the same as those in Example 2 except for those to be particularly described below.

Furthermore, the processing flow of the data migration management program 272 is the same as that shown in FIG. 25 in Example 2.

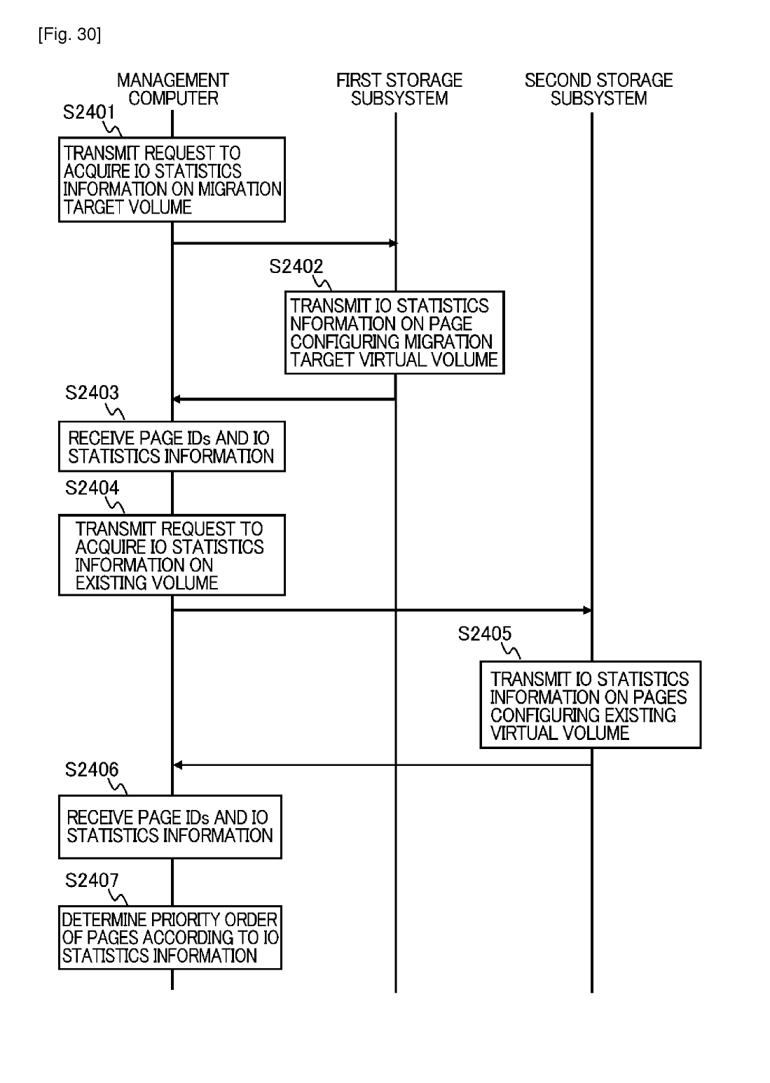

First, the “process of acquiring IO statistics information of a page” in S2004 in FIG. 25 will be described. FIG. 30 shows an example of the detailed processing flow of the “process of acquiring IO statistics information of a page.” In this example, the IO statistics information is acquired not only from the first storage subsystem 300 but also from the second storage subsystem 400.

First, the data migration management program 272 in the management computer 200 transmits a request to acquire IO statistics information on the virtual volume 373 to be the migration target, to the first storage subsystem 300 (S2401). The request to acquire IO statistics information includes the IDs of one or multiple virtual volumes 373 to be the migration targets.

Next, the tier control program 354 in the first storage subsystem 300 transmits the IO statistics information of the target volume to the management computer 200. The IO statistics information is information on IO frequency monitored for each of the pages 372 forming the virtual volume 373 of the migration target, and may be information managed in the IO monitor management table 35b shown in FIG. 11 in Example 1.

The input/output management program 271 in the management computer 200 receives the page-unit IO statistics information, and then transmits the page-unit IO statistics information thus received to the data migration management program 272 (S2403).

The data migration management program 272 transmits a request to acquire IO statistics information on an existing virtual volume 373 in the second storage subsystem 400, to the second storage subsystem 400 (S2404).

The tier control program 354 in the second storage subsystem 400 refers to the IO monitor management table 35b, and transmits the IO statistics information on the existing virtual volume 373 to the management computer 200 (S2405). This IO statistics information is information on IO frequency monitored for each of the pages 372 forming the existing virtual volume 373, and may be the information managed in the IO monitor management table 35b shown in FIG. 11 in Example 1.

The input/output management program 271 receives the page-unit IO statistics information, and transmits the page-unit IO statistics information thus received to the data migration management program 272 (S2406).

The data migration management program 272 determines a priority order of each of the pages 372 on the basis of the IO statistics information received from each of the first storage subsystem 300 and the second storage subsystem 400 (S2407). The priority orders of the pages 372 are determined on the basis of the IO statistics information, and are defined in the example as priorities in descending order of the number of IOs in a predetermined period of time. In addition, the priority orders are those of the pages 372 of the migration target volume in the first storage subsystem 300 as well as the pages 372 of the existing volumes in the second storage subsystem 400 mixed with one another, as will be described later in connection with FIG. 30.

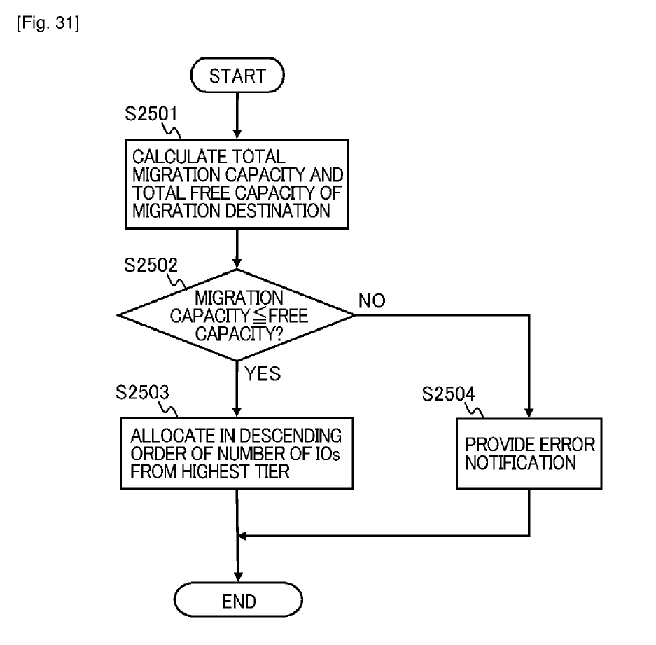

Next, the “process of determining a storage tier configuration after migration” in S2005 in FIG. 25 will be described. FIG. 31 shows an example of the detailed processing flow of the “process of determining a storage tier configuration after migration.”

First, the data migration management program 272 in the management computer 200 refers to information in the storage subsystem tier configuration management tables 273, and thus calculates the total capacity of the migration target volume and the total free capacity of the migration destination (S2501).

The data migration management program 272 determines whether the total free capacity of the migration destination is not less than the total capacity of the migration target volume (S2502). When the data migration management program 272 determines that the total free capacity of the migration destination is not less than the total capacity of the migration target volume (Yes in S2502), the data migration management program 272 proceeds the processing to S2503. On the other hand, when the data migration management program 272 determines that the total free capacity of the migration destination is less than the total capacity of the migration target volume (No in S2502), the data migration management program 272 provides an error notification through the output device 240 or the like of the management computer 200 (S2504).

In S2503, the data migration management program 272 in the management computer 200 allocates, in descending order of the number of IOs, the pages 372 in the migration destination and the migration source from the highest tier of the migration destination.

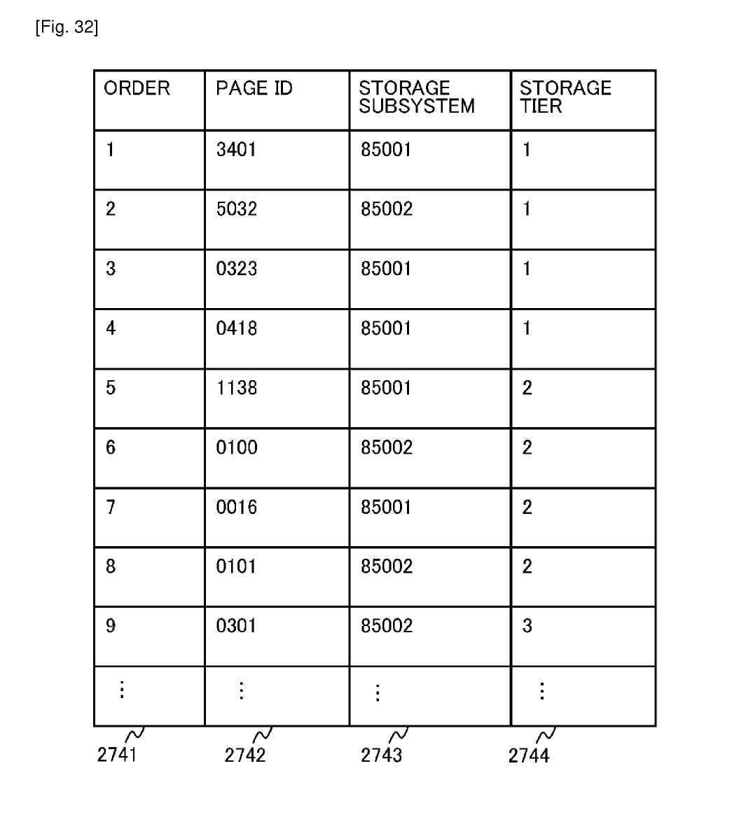

FIG. 32 is a diagram showing an example of relations between the migration order of the pages 372 determined on the basis of the result of the processing in S2004 as well as S2005 in FIG. 25 and the storage tiers in which the pages 372 are allocated in the migration destination storage subsystem. In FIG. 32, an order 2741 indicates the priority order of each page, a page ID 2742 indicates an identification code for uniquely identifying each page, a storage subsystem 2743 indicates the ID of a storage subsystem to which each page belongs before data migration, and a storage tier 2744 indicates a storage tier to which each page is to be allocated after migration in the migration destination storage subsystem.

For example, it is found from FIG. 32 that the page whose priority order is 1 is a page specified by the page ID “3401”, belongs to the storage subsystem “85001” before migration, and is to be allocated to the storage tier 1 in the migration destination.

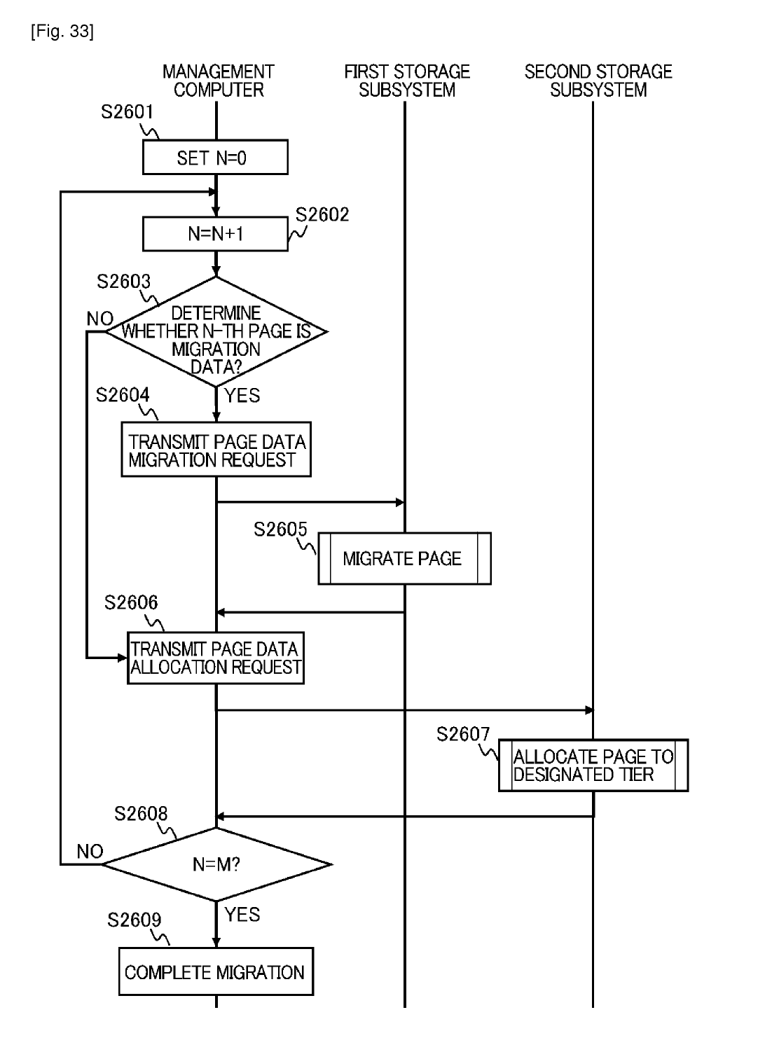

Next, the processing flow to be executed on migration data and existing data by the virtual volume management program in the migration destination storage subsystem in connection with the data migration in this example will be described. FIG. 33 shows an example of the processing flow executed on migration data and existing data by the virtual volume management program in connection with the data migration.

First, the data migration management program 272 in the management computer 200 sets zero in the priority order N for the pages 372 as an initial value (S2601).

The data migration management program 272 adds 1 to the priority order N, and sequentially executes processes starting from S2603 (S2602).

The data migration management program 272 determines whether or not the page 372 of the priority order N is migration data (S2603). When the data migration management program 272 determines that the page 372 of the priority order N is migration data (Yes in S2603), the data migration management program 272 proceeds the processing to S2604. On the other hand, when the data migration management program 272 determines that the page 372 of the priority order N is not migration data (that the page 372 is data that has already been stored in the migration destination storage subsystem) (No in S2603), the data migration management program 272 proceeds the processing to S2606.

In S2604, the data migration management program 272 issues a data migration request for the page 372 of the priority order N to the first storage subsystem 300 (S2604). Upon receipt of the request, the virtual volume management program 353 in the first storage subsystem 300 executes the migration processing on the page 372 designated (S2605). The details of this processing will be described later.

Next, the data migration management program 272 in the management computer 200 issues a request to allocate the designate page data to the designated tier, to the second storage subsystem 400 (S2606). Upon receipt of the request, the virtual volume management program 353 in the second storage subsystem 400 allocates the designated page data to the designated tier (S2607). The details of this processing will also be described later.

The data migration management program 272 determines whether or not the priority order N is equal to a total number of pages M that is the total of the number of migration pages and the number of existing pages (S2608). When the data migration management program 272 determines that the priority order N is equal to the total number of pages M (Yes in S2608), the processing is completed (S2609). On the other hand, when the data migration management program 272 determines that the priority order N is not equal to the total number of pages M (No in S2608), the data migration management program 272 returns the processing to S2602.

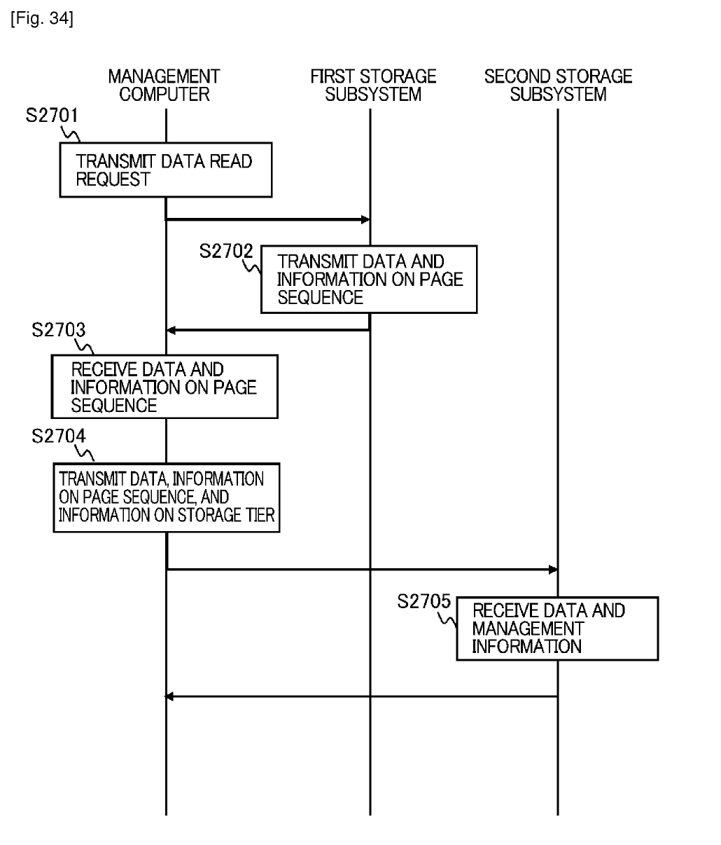

Next, the “page migration processing” in S2605 in FIG. 33 will be described. FIG. 34 shows an example of the detailed processing flow of the “page migration processing.”

First of all, the data migration management program 272 in the management computer 200 issues a page data read request to the first storage subsystem 300 (S2701). The data read request includes at least the page ID.

Next, upon receipt of the data read request, the management information input/output program 351 in the first storage subsystem 300 transmits data stored in the designated page and information on the page sequence thereof to the management computer 200 (S2702).

The management computer 200 receives the data and the information on the page sequence of the designated page (S2703). Then, the management computer 200 transmits, to the second storage subsystem 400, the data and the information on the page sequence of the designated page while attaching thereto information on the storage tier, which is to be allocated to the page, in the migration destination storage subsystem (S2704).

The second storage subsystem 400 receives the data and management information transmitted from the management computer 200 (S2705).

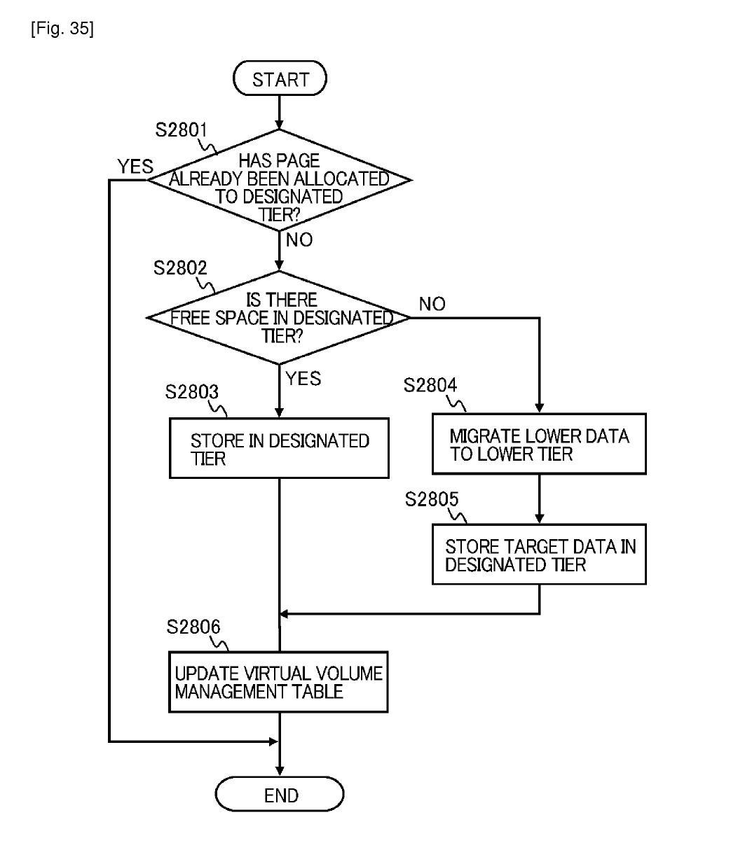

Next, the “process of allocating a page to a designated tier” in S2607 in FIG. 33 will be described. FIG. 35 shows an example of the detailed processing flow of the “process of allocating a page to a designated tier.”

First, the virtual volume management program 353 in the second storage subsystem 400 determines whether or not the page 372 has already been allocated to the designated tier in the designated subsystem (S2801). When the virtual volume management program 353 determines that the page 372 has already been allocated (Yes in S2801), the rest of the processing is not performed but the processing is terminated. On the other hand, when the virtual volume management program 353 determines that the page 372 has not been allocated to the designated tier in the designated subsystem yet (No in S2801), the virtual volume management program 353 proceeds the processing to S2802.

Next, the virtual volume management program 353 determines whether or not there is a free space having an enough capacity for the page, in the designated storage tier in the second storage subsystem 400 (S2802). When the virtual volume management program 353 determines that there is a free space having an enough capacity for the page (Yes in S2802), the virtual volume management program 353 proceeds the processing to S2803. On the other hand, when the virtual volume management program 353 determines that there is no free space having an enough capacity for the page (No in S2802), the virtual volume management program 353 proceeds the processing to S2804.

In S2803, since there is a free space in the designated storage tier in the second storage subsystem 400, the virtual volume management program 353 stores or migrates the data to the storage area in the designated tier.

On the other hand, in S2804, the virtual volume management program 353 migrates part of the data stored in the designated tier to a free space in a lower tier than the designated tier, the part corresponding to a page having a lower priority order than the priority order N. Subsequently, the virtual volume management program 353 stores the page data of the priority order N to the space made available by the processing in S2804 (S2805).

After that, the virtual volume management program 353 updates the virtual volume management table 358 stored in the second storage subsystem 400 (S2806).

With the above-described processing, the data migration between storage subsystems can be executed in accordance with the priority orders of pages defined on the basis of the IO statistics information.

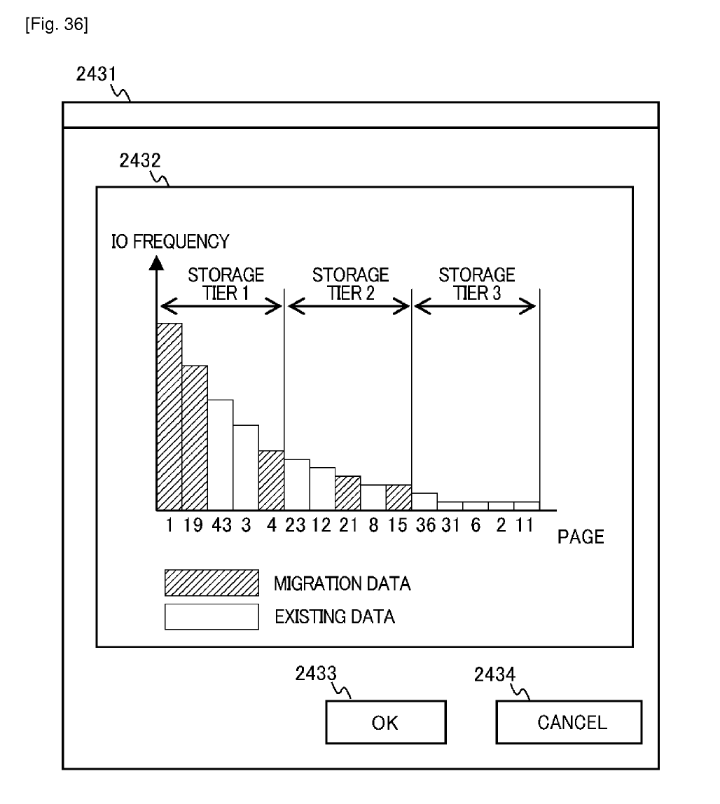

FIG. 36 shows an example of a management screen 2431 outputting the page-unit IO statistics information collected at the time of data migration and a result of calculating the priority order of each page.

The management screen 2431 includes at least a display part 2432 configured to display the page-unit IO statistics information, a confirmation button 2433, and a cancel button 2434. The display part 2432 has a graph configured to display pages while arranging the pages in descending order of IO frequency. In the example shown in FIG. 36, the pages displayed in the graph are visually distinguished so that it can be determined whether each of the pages is migration data or existing data in the migration destination storage subsystem. Additionally, ranges of storage tiers in the migration destination may be shown in the graph.

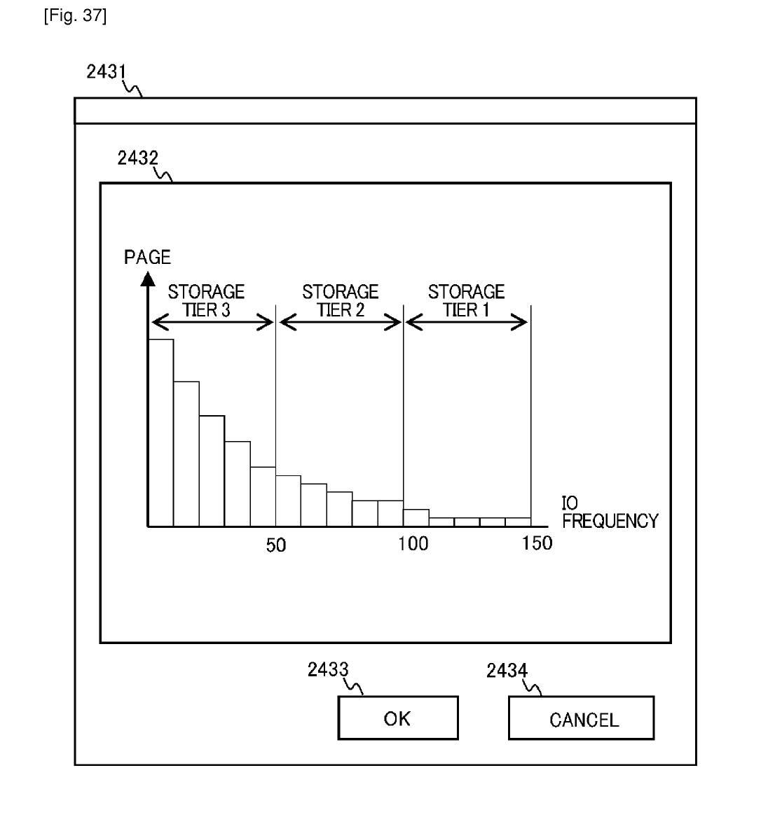

FIG. 37 shows another example of the management screen 2431 shown in FIG. 36. The management screen 2431 in FIG. 37 includes a display part 2436 configured to display, as a graph, a frequency distribution of the IO frequency and the number of pages and the ranges of storage tiers in the storage subsystem, for example. The management screen 2431 may be utilized by the administrator for the purpose of checking the state of execution of a tier control program in the first storage subsystem 300 before migration or in the second storage subsystem 400 after migration, and other purposes.

Note that, this example may be employed, in the same manner, for a case of data migration, for example, where there are multiple first storage subsystems each of which is the migration source, and data is to be gathered in a second storage subsystem which is the migration destination. In this case, the IO statistics information may be collected from the virtual volumes of all the first storage subsystems that are the targets for data migration. Then, the priority orders of the respective pages may be determined together with existing volumes in the migration destination

According to the examples of the present invention described so far, it is possible to migrate data to the virtual volume 373 in the migration destination storage subsystem while maintaining the storage tier configuration held in the virtual volume 373 in the migration source storage subsystem.

Although the invention of the present application has been described with reference to the accompanying drawings on the basis of the examples of the invention, the invention of the present application is not limited to these examples. Moreover, any modifications and equivalents that do not depart from the spirit of the invention of the present application are also within the scope of the invention of the present application.

1. A management system for a storage system, the storage system including a first storage subsystem and a second storage subsystem each including logical storage areas for storing data to be processed by a host computer, the logical storage areas in each of the first and second storage subsystems having storage tiers associated respectively with a plurality of storage area characteristic information pieces which are information pieces characterizing the corresponding logical storage areas and which are different from each other,
the management system comprising a data migration management part that, when the data is migrated from the first storage subsystem to the second storage subsystem,
acquires a configuration of the storage tiers of the logical storage areas of the first storage subsystem in which the data of a migration target is stored;
compares the configuration with a configuration of the storage tiers of the logical storage areas of the second storage subsystem; and
migrates the migration target data stored in the logical storage areas of the first storage subsystem to the logical storage areas of the second storage subsystem in accordance with a result of the comparison.

2. The management system for the storage system, according to claim 1, wherein:
the data migration management part determines whether or not the migration target data in the logical storage areas of the first storage subsystem can be migrated to one of the logical storage areas of the second storage subsystem, the one logical storage area being associated with the same storage area characteristic information piece as that associated with each of the logical storage areas to which the migration target data belongs;
when the data migration management part determines that the migration target data in the first storage subsystem can be migrated to one of the logical storage areas of the second storage subsystem associated with the same storage area characteristic information piece as that associated with each of the logical storage areas to which the migration target data belongs,
the data migration management part
creates storage area characteristic correspondence information in which one or more storage area management units and the storage area characteristic information pieces of the respective storage area management units are held in association with each other, the storage area management units being obtained by managing each of the logical storage areas of the first storage subsystem as one or a plurality of unit storage areas, and
in accordance with the storage area characteristic correspondence information, designates, as a migration destination, one of the storage tiers of the logical storage areas of the second storage subsystem, and migrates the migration target data in the first storage subsystem to the designated storage tier in the second storage subsystem;
when the data migration management part determines that the migration target data in the first storage subsystem cannot be migrated to one of the logical storage areas of the second storage subsystem associated with the same storage area characteristic information piece as that associated with each of the logical storage areas to which the migration target data belongs,
the data migration management part
creates storage area characteristic correspondence information in which storage area management units and the storage area characteristic information pieces of the respective storage area management units are held in association with each other, the storage area management units being obtained by managing each of the logical storage areas of the first storage subsystem as one or a plurality of unit storage areas, and in accordance with the storage area characteristic correspondence information, migrates part of the migration target data in the first storage subsystem to an available one of the logical storage areas of the second storage subsystem, the part being incapable of being migrated to the one logical storage area of the second storage subsystem associated with the same storage area characteristic information piece as that associated with each of the logical storage areas to which the migration target data belongs, the available logical storage area being available for the data migration and associated with the storage area characteristic information piece classified to be superior to the storage area characteristic information piece of the each of the logical storage areas to which the migration target data belongs;
when the storage area characteristic information piece further includes storage area performance information that is information indicating a performance of each storage medium providing the corresponding logical storage area, and when the data migration management part migrates, to the logical storage areas of the second storage subsystem in accordance with the storage area characteristic correspondence information, the part of the migration target data in the first storage subsystem incapable of being migrated to the one logical storage area of the second storage subsystem associated with the same storage area characteristic information piece as that associated with each of the logical storage areas to which the migration target data belongs, the data migration management part migrates the part to one of the logical storage areas which is available for the data migration and is associated with the storage area performance information classified to be equal or superior in performance to the storage area performance information of the each of the logical storage areas to which the migration target data belongs;
when the data migration management part acquires and holds data characteristic information for each of the storage area management units in which the migration target data is stored in the first storage subsystem, the data characteristic information being characteristic information specified for the data stored in each of the storage area management units, and when the data migration management part migrates the migration target data in the first storage subsystem to the logical storage areas of the second storage subsystem, the data migration management part migrates the migration target data to the logical storage areas of the second storage subsystem in accordance with a priority order defined on the basis of the data characteristic information associated with the migration target data in the first storage subsystem;
when data is already stored in the logical storage area of the second storage subsystem designated as a migration destination, the data migration management part acquires and holds, for each storage area management unit, the data characteristic information on the data stored in the logical storage area of the second storage subsystem, and stores the migration target data in the plurality of the first storage subsystems and the data characteristic information associated with the data stored in the second storage subsystem in the logical storage area of the second storage subsystem in accordance with a priority order determined by merging the priority order defined on the data characteristic information associated with the migration target data in the plurality of the first storage subsystems and the priority order defined on the data characteristic information associated with the data stored in the second storage subsystem.

3. The management system for the storage system, according to claim 1, wherein
the data migration management part determines whether or not the migration target data in the logical storage areas of the first storage subsystem can be migrated to one of the logical storage areas of the second storage subsystem, the one logical storage area being associated with the same storage area characteristic information piece as that associated with each of the logical storage areas to which the migration target data belongs.

4. The management system for the storage system, according to claim 3, wherein
when the data migration management part determines that the migration target data in the first storage subsystem can be migrated to one of the logical storage areas of the second storage subsystem associated with the same storage area characteristic information piece as that associated with each of the logical storage areas to which the migration target data belongs,
the data migration management part:
creates storage area characteristic correspondence information in which one or more storage area management units and the storage area characteristic information pieces of the respective storage area management units are held in association with each other, the storage area management units being obtained by managing each of the logical storage areas of the first storage subsystem as one or a plurality of unit storage areas; and
in accordance with the storage area characteristic correspondence information, designates, as a migration destination, one of the storage tiers of the logical storage areas of the second storage subsystem, and migrates the migration target data in the first storage subsystem to the designated storage tier in the second storage subsystem.

5. The management system for the storage system, according to claim 3, wherein
when the data migration management part determines that the migration target data in the first storage subsystem cannot be migrated to one of the logical storage areas of the second storage subsystem associated with the same storage area characteristic information piece as that associated with each of the logical storage areas to which the migration target data belongs,
the data migration management part:
creates storage area characteristic correspondence information in which storage area management units and the storage area characteristic information pieces of the respective storage area management units are held in association with each other, the storage area management units being obtained by managing each of the logical storage areas of the first storage subsystem as one or a plurality of unit storage areas; and
in accordance with the storage area characteristic correspondence information, migrates part of the migration target data in the first storage subsystem to an available one of the logical storage areas of the second storage subsystem, the part being incapable of being migrated to the one logical storage area of the second storage subsystem associated with the same storage area characteristic information piece as that associated with each of the logical storage areas to which the migration target data belongs, the available logical storage area being available for the data migration and associated with the storage area characteristic information piece classified to be superior to the storage area characteristic information piece of the each of the logical storage areas to which the migration target data belongs.

6. The management system for the storage system, according to claim 5, wherein
the storage area characteristic information piece further includes storage area performance information that is information indicating a performance of each storage medium providing the corresponding logical storage area,
when the data migration management part migrates, to the logical storage areas of the second storage subsystem in accordance with the storage area characteristic correspondence information, the part of the migration target data in the first storage subsystem incapable of being migrated to the one logical storage area of the second storage subsystem associated with the same storage area characteristic information piece as that associated with each of the logical storage areas to which the migration target data belongs,
the data migration management part migrates the part to one of the logical storage areas which is available for the data migration and is associated with the storage area performance information classified to be equal or superior in performance to the storage area performance information of the each of the logical storage areas to which the migration target data belongs.

7. The management system for the storage system, according to claim 5, wherein
the data migration management part acquires and holds data characteristic information for each of the storage area management units in which the migration target data is stored in the first storage subsystem, the data characteristic information being characteristic information specified for the data stored in each of the storage area management units; and
when the data migration management part migrates the migration target data in the first storage subsystem to the logical storage areas of the second storage subsystem, the data migration management part migrates the migration target data to the logical storage areas of the second storage subsystem in accordance with a priority order defined on the basis of the data characteristic information associated with the migration target data in the first storage subsystem.

8. The management system for the storage system, according to claim 7, wherein
the storage system includes a plurality of the first storage subsystems, and
the data migration management part migrates the migration target data to the logical storage areas of the second storage subsystem in accordance with a priority order defined on the basis of the data characteristic information associated with the migration target data in the plurality of the first storage subsystems.

9. The management system for the storage system, according to claim 7, wherein:
when data is already stored in the logical storage area of the second storage subsystem designated as a migration destination, the data migration management part acquires and holds, for each storage area management unit, the data characteristic information on the data stored in the logical storage area of the second storage subsystem, and stores the migration target data in the first storage subsystems and the data stored in the second storage subsystem in the logical storage area of the second storage subsystem in accordance with a priority order determined by merging the priority order defined on the data characteristic information associated with the migration target data in the first storage subsystems and the priority order defined on the data characteristic information associated with the data stored in the second storage subsystem.

10. The management system for the storage system, according to claim 9, wherein
the storage system includes a plurality of the first storage subsystems, and
the data migration management part stores the migration target data in the plurality of the first storage subsystem and the data stored in the second storage subsystem in the logical storage area of the second storage subsystem in accordance with a priority order determined by merging the priority order defined on the data characteristic information pieces associated with the migration target data in the plurality of the first storage subsystems and the priority order defined on the data characteristic information pieces associated with the data stored in the second storage subsystem.

11. A method for managing a storage system, the storage system including a first storage subsystem and a second storage subsystem each including logical storage areas for storing data to be processed by a host computer, the logical storage areas in each of the first and second storage subsystems having storage tiers associated respectively with a plurality of storage area characteristic information pieces which are information pieces characterizing the corresponding logical storage areas and which are different from each other, the method using a data migration management part configured to manage data migration processing of migrating data stored in the first storage subsystem to the second storage subsystem,
the method comprising causing the data migration management part to execute the steps of:
when the data is migrated from the first storage subsystem to the second storage subsystem,
acquiring a configuration of the storage tiers of the logical storage areas of the first storage subsystem in which the data of a migration target is stored;
comparing the configuration with a configuration of the storage tiers of the logical storage areas of the second storage subsystem; and then migrating the migration target data stored in the logical storage areas of the first storage subsystem to the logical storage areas of the second storage subsystem in accordance with a result of the comparison.

12. The method for managing the storage system, according to claim 11, wherein
the data migration management part determines whether or not the migration target data in the logical storage areas of the first storage subsystem can be migrated to one of the logical storage areas of the second storage subsystem, the one logical storage area being associated with the same storage area characteristic information piece as that associated with each of the logical storage areas to which the migration target data belongs.

13. The method for managing the storage system, according to claim 12, wherein
when the data migration management part determines that the migration target data in the first storage subsystem can be migrated to one of the logical storage areas of the second storage subsystem associated with the same storage area characteristic information piece as that associated with each of the logical storage areas to which the migration target data belongs,
the data migration management part:
creates storage area characteristic correspondence information in which storage area management units and the storage area characteristic information pieces of the respective storage area management units are held in association with each other, the storage area management units being obtained by managing each of the logical storage areas of the first storage subsystem as one or a plurality of unit storage areas; and
in accordance with the storage area characteristic correspondence information, designates, as a migration destination, one of the storage tiers of the logical storage areas of the second storage subsystem, and migrates the migration target data in the first storage subsystem to the designated storage tier in the second storage subsystem.

14. The method for managing the storage system, according to claim 12, wherein
when the data migration management part determines that the migration target data in the first storage subsystem cannot be migrated to one of the logical storage areas of the second storage subsystem associated with the same storage area characteristic information piece as that associated with each of the logical storage areas to which the migration target data belongs,
the data migration management part:
creates storage area characteristic correspondence information in which storage area management units and the storage area characteristic information pieces of the respective storage area management units are held in association with each other, the storage area management units being obtained by managing each of the logical storage areas of the first storage subsystem as one or a plurality of unit storage areas; and
in accordance with the storage area characteristic correspondence information, migrates part of the migration target data in the first storage subsystem to an available one of the logical storage areas of the second storage subsystem, the part being incapable of being migrated to the one logical storage area of the second storage subsystem associated with the same storage area characteristic information piece as that associated with each of the logical storage areas to which the migration target data belongs, the available logical storage area being available for the data migration and associated with the storage area characteristic information piece classified to be superior to the storage area characteristic information piece of the each of the logical storage areas to which the migration target data belongs.

15. The method for managing the storage system, according to claim 11, wherein
the storage area characteristic information piece further includes storage area performance information that is information indicating a performance of each storage medium providing the corresponding logical storage area,
when the data migration management part migrates, to the logical storage areas of the second storage subsystem in accordance with the storage area characteristic correspondence information, the part of the migration target data in the first storage subsystem incapable of being migrated to the one logical storage area of the second storage subsystem associated with the same storage area characteristic information piece as that associated with each of the logical storage areas to which the migration target data belongs,
the data migration management part migrates the part to one of the logical storage areas which is available for the data migration and is associated with the storage area performance information classified to be equal or superior in performance to the storage area performance information of the each of the logical storage areas to which the migration target data belongs.
